(19) United States
(12) Patent Application Publication
(10) Pub. No.: US 2010/0146995 A1
(43) Pub. Date: Jun. 17, 2010

(54) AIR CONDITIONING METHODS AND APPARATUS

(76) Inventor: David Richard Mathews, Corpus Christi, TX (US)

Correspondence Address: GEORGE S. GRAY, P. O. Box 270190, CORPUS CHRISTI, TX, 78427-0190, US

(21) Appl. No.: 12/600,651

(22) PCT Filed: May 28, 2008
(86) PCT No.: PCT/US08/65009

§ 371 Date: Nov. 17, 2009

Related U.S. Application Data
(60) Provisional application No. 60/941,508, filed on Jun. 1, 2007.

(51) Int. Cl. F25B 1/00; F25D 17/06; G05B 15/00

(52) U.S. Cl. 62/115; 62/93; 700/275

(57) ABSTRACT

Methods and apparatus are provided for enhancing the performance of air conditioning systems (heat pump and traditional) in both cooling and heating modes, in some exemplary embodiments using a controller providing electronic circuitry to enable three stage fan activation at the beginning of a cooling cycle and defeat and avoidance of the now-common forced fan activation after compressor deactivation. In some exemplary embodiments the device enables two stage fan activation at the beginning of a heating cycle (for heat pump systems). In some exemplary embodiments the circuitry is a combination of conventional wiring, relays, and dip switches, and in some exemplary embodiments a microprocessor is provided.

### CROSS-REFERENCE TO RELATED APPLICATION

This application claims priority from U.S. Provisional Patent Application Ser. No. 60/941,508 filed Jun. 1, 2007, by the inventor herein, David Richard Mathews.

### TECHNICAL FIELD OF THE INVENTION AND INDUSTRIAL APPLICABILITY

The field of the invention is air conditioning, or, more specifically, methods and apparatus for enhancing the cooling, heating, and dehumidifying performance of typical air conditioners with respect to air circulated in buildings.

### BACKGROUND OF THE INVENTION

Air conditioning systems in wide use today include systems with a compressor, condenser, expansion valve, inside cooling coil, and a fan for blowing return air across the cooling coil, where it is cooled and dehumidified prior to its return to the building. In some instances, a reversing valve is provided to allow use as a heat pump, where the inside cooling coil becomes a heating coil and the air returning to the building is heated. In other instances, an inside heating coil is provided in addition to the cooling coil, and the fan moves air across the heating coil for heating when the system is in the heating mode. The heating coil is typically heated by electricity or gas. User controls are provided that signal such systems to begin the cooling cycle, terminate the cooling cycle, begin the heat cycle, and/or terminate the heat cycle. In typical air conditioners and heat pumps the signal to initiate cooling activates the compressor, and the signal to terminate cooling deactivates the compressor.

In the typical conventional air conditioning system, the most inefficient time in the cooling cycle is at the start-up of the system. Typically, it will require 8 to 10 minutes of operation for the system to reach its peak cooling efficiency and its peak dehumidification capacity. The compressor is typically under a full load at the initiation of the cooling cycle, which slows the compressor's ability to reach its peak efficiency.

Additionally, in normal operation of such conventional systems, the cooling coil causes moisture to condense from the return air, with droplets of such condensed water accumulating on the cooling coil. During the cooling cycle some such droplets drain from the cooling coil to a drain pan. However, in a typical system, a significant amount of such condensation remains on the cooling coil when the compressor is deactivated. When the system is signaled to start again, the fan starts blowing warm air from the building across the temporarily warm and wet cooling coil. When this happens the system blows newly moisturized, warm air into the building—air which must be cooled and dehumidified before any net gain in cooling and dehumidification, above the initial conditions, can be felt by the building occupants. Compounding the problem, this initial supply of warm air is often warmer than the air in the building generally in that the system is often located in hot attics, where imperfectly sealed ducts and exposed equipment tend to warm the air proximate the blower. When starting under these conditions, it typically requires about 8 minutes of operation to get the cooling coil cold and moist to start the dehumidification process.

In such conventional systems, when user controls signal a termination of the air conditioning cycle, if the fan is deactivated at the time the compressor is terminated, and remains deactivated for a sufficient amount of time, a significant portion of these condensation droplets will drain from the cooling coil. Two widely present phenomena interfere with this desirable drainage. The first such interfering phenomenon arises from the fact that air conditioner manufacturers increase their system's Seasonal Energy Efficiency Ratio (SEER) ratings by forcing the fan to remain activated for approximately 30-45 seconds in order to capture the last measure of cooling available from the still cool cooling coils. While this technique may improve the SEER rating, it should be noted that the SEER rating is not based on the effective dehumidifying performance of the system being rated. The practice of forcing the fan to remain activated after compressor deactivation does utilize some of the last remaining coolness from the cooling coils, but it does so at the expense of reintroducing much of the remaining water droplets on the cooling coil into the air being blown across the cooling coil. This raises the humidity of the conditioned air, and significantly reduces the overall dehumidification performance of the system. As is well known, humidity in the conditioned air can cause even cool air to leave building occupants uncomfortable, often leading the occupant to set the controls such that the system is signaled to run more often.

The second such interfering phenomenon is the continuous fan mode present as a user controlled option in many current systems, where the fan continues to be activated, usually at a reduced speed, even after a signal is received to terminate the cooling cycle. In this mode, the fan will continue to run at reduced speed until the system receives a signal to start the next cooling cycle, at which time the fan is activated to full speed along with the compressor. Even at reduced fan speed, the air blowing across the cooling coil after compressor deactivation will re-evaporate droplets from the cooling coil back into the air going to the building, which prevents a large amount of the water on the cooling coil from draining from the coil to the drain pan, as desired.

A related problem arises which relates to both of the foregoing interfering phenomena. Some current systems are programmed to force the fan to remain activated at full speed after compressor deactivation for a substantial period of time, when the system is not in the continuous fan mode, but are also programmed to change nothing if the system is in continuous fan mode. This programming follows the logic that the remaining coolness in the cooling coil will be adequately utilized whether the fan is on reduced speed indefinitely, or is on full speed for a substantial time period. In both situations, the failure to deactivate the fan as the compressor is deactivated results in unnecessary humidity being reintroduced into the air moving past the cooling coil. In such systems, previous programming causes the forced full speed fan activation feature to be cancelled upon determining that the fan has been shifted to the reduced fan speed associated with the continuous fan mode, such that within approximately 1-5 seconds after the compressor is deactivated the forced full fan speed will be preempted and the fan allowed to run at reduced speed in the continuous fan mode.

In a conventional heat pump system, when signaled for heat, the inside fan is immediately activated, prior to the inside coil being warmed, which causes a blast of cold air to be sent to the building. Furthermore, when signaled to terminate the heat cycle, the fan and compressor are deactivated simultaneously, with no provision made to utilize the heat remaining in the inside coil. Similarly, a conventional air conditioning system, with a separate heating coil, responds to a signal for heat by simultaneously activating the fan and the separate heating coil. Since the separate heating coil, being electrically heated, becomes warm faster than in a heat pump system, the cold air blast phenomenon is reduced, however, no provision is made to utilize the heat remaining in the separate heating coil at the end of the cycle.

Currently, variable speed air conditioning units are available, which have what is referred to as an enhanced mode wherein the fan runs at a reduced speed for 8½ minutes every time the system is signaled to start in the cooling mode. However when the cooling cycle is initiated with this reduced fan speed time interval, the system components, ductwork, and grilles often condense water and sweat. In analogous fashion, U.S. Pat. No. 7,191,607, by Morton Curtis, provides a reduced fan speed at the start of a conditioning cycle, that remains at a reduced speed for a recommended 5-7 minutes before full fan speed is initiated.

U.S. Pat. No. 3,762,178, by Kaitti Yamada, et al., provides a system where the fan activation is delayed for a period of time (about 30 seconds) before activation at full speed. This technique puts an immediate full load on the compressor when the fan is finally activated, which increases the time necessary for the system to reach its peak capacity and efficiency. Starting the fan at full speed can cause the coil temperature to rise above the dew point and destabilize any dew on the cooling coil which can cause re-evaporation of the moisture into the building. This will increase the time it takes the system to reach its peak dehumidification capacity and decrease the overall dehumidification capacity of the system. The Yamada et al. system does not address the above-described problems and inefficiencies concerning the heating mode, nor does it address the water droplets remaining on the inside cooling coil at the termination of the cooling cycle.

U.S. Pat. No. 5,743,100, by Welguisz, et al. provides a system where the fan activation is delayed by approximately 45 seconds at the beginning of the cooling cycle. The fan is then activated at full speed. Again, this technique puts an immediate full load on the compressor when the fan is finally activated, which increases the time necessary for the system to reach its peak capacity and efficiency, and can cause sweating of the system, ducts, and grilles. Furthermore, Welguisz, et al. are critical of systems whereby the fan and compressor are simultaneously deactivated at the end of the cooling cycle, and they force the fan to remain activated for a substantial period of time (up to about 80 seconds) after the compressor has been deactivated. As discussed above, this unnecessarily reintroduces water into the air sent to the building. The above heating mode concerns are not addressed.

U.S. Pat. No. 4,672,816, by Tadahiro Takahashi, provides a system where the fan activation is delayed until the moisture condenses on the cooling coil, and is then activated at full speed. The compressor is forced to run at a maximized capacity while the fan is deactivated, and at a normal capacity when the fan is activated. As mentioned above, this slows the compressor's ability to reach its peak efficiency, and only works with multi-stage compressors. The Takahashi system does not address the above-described problems and inefficiencies concerning the heating mode, nor does it address the water droplets remaining on the inside cooling coil at the termination of the cooling cycle.

U.S. Pat. No. 4,941,325, by Douglas J. Nuding, provides a system where the outside condenser fan is initiated first, then the compressor is activated, followed by the fan. Like Welguisz, et al., Nuding is critical of systems whereby the fan and compressor are simultaneously deactivated at the end of the cooling cycle, and Nuding forces the fan to remain activated for a substantial period of time after the compressor has been deactivated. As discussed above, this unnecessarily reintroduces water into the air sent to the building. The above heating mode concerns are not addressed.

What is needed is an air conditioning system and methods that address all the foregoing problems, such that water droplets remaining on the inside cooling coil when the cooling cycle is initiated, and after compressor deactivation, are not reintroduced into the building air, the time required to reach the system's peak capacity and efficiency is reduced, cold air blasts are minimized at initiation of the heat mode in a heat pump system, and heat remaining in heat pump inside coils, and separate inside heating coils, is effectively utilized at the termination of the heat mode.

### SUMMARY OF THE INVENTION

My invention provides an air conditioning system that addresses all the above-described problems, such that (a) when the system is signaled to begin the cooling cycle, (1) the fan activation is delayed for an adjustable period of time to allow the cooling coil to begin cooling and to avoid blowing pre-existing water droplets on the cooling coil into the air that would be moving to the building, (2) the compressor operates at less than a full load while the fan is so deactivated, to reduce the time required to reach the compressor's peak capacity, (3) the period of fan deactivation is followed by an adjustable period of reduced fan speed to help maintain the pre-cooled condition of the cooling coil and to further avoid blowing remaining droplets from the cooling coil into the air now moving to the building, (4) the compressor operates at less than a full load while the fan is activated at such reduced speed, to further reduce the time required to reach the compressor's peak capacity, and (5) the period of fan activation at reduced speed is followed by full speed fan activation, to timely take advantage of the now fully-cooled coil and the stabilized water droplets, and (b) when the system is signaled to terminate the cooling cycle, (1) the compressor and cooling coil fan are simultaneously deactivated in systems that are not previously programmed to force the fan to remain activated after compressor deactivation, (2) the forced full fan speed activation period after compressor deactivation is cancelled, in systems that are programmed to force the fan to remain activated after compressor deactivation, and (3) the fan is deactivated for a period of time as necessary to optimize the drainage of water droplets from the cooling coil, (c) when a heat pump system receives a signal to initiate heating, (1) the inside fan activation is delayed so as to avoid blowing cold air into the building due to the inside coil being cool prior to the compressor being activated, (2) the inside fan is activated to full speed following the delay, thus blowing the initial air across a warmed coil, and (3) the fan deactivation, in response to a signal to the system to terminate the heating cycle, is delayed, thus allowing the fan to continue blowing across the inside coil until all available heat is transferred to the blowing air, and (d) when a system with a separate inside coil receives a signal to terminate the heating cycle, the inside fan deactivation is delayed, thus allowing the fan to continue blowing across the inside coil until substantially all available heat is transferred to the blowing air.

In some exemplary embodiments of my invention I have provided a method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising: alternately activating and deactivating the compressor and alternately activating and deactivating the air mover, the air mover activation comprising a first stage of zero speed, a second stage of reduced speed, and a third stage of substantially full speed; responding to a conditioning initiation signal from the conditioner initiator such that the compressor is activated, the condenser is activated and the air mover begins the air mover first stage; initiating the air mover second stage following the air mover first stage; and initiating the air mover third stage following the air mover second stage.

In some exemplary embodiments, the method further comprises responding to a conditioning termination signal from the conditioner initiator by simultaneously deactivating the compressor and the air mover.

In some exemplary embodiments, the method further comprises responding to a conditioning termination signal from the conditioner initiator by deactivating the compressor, reducing the air mover speed for approximately 1-5 seconds beginning at the compressor deactivation, and then deactivating the air mover.

In some exemplary embodiments, the air mover is normally continuously activated, and the method further comprises responding to a conditioning termination signal from the conditioner initiator by deactivating the compressor and deactivating the air mover, the air mover deactivation being for an extended time period.

In some exemplary embodiments, responding to a conditioning termination signal from the conditioner initiator further comprises deactivating the compressor, reducing the air mover speed for approximately 1-5 seconds beginning at the compressor deactivation, and then deactivating the air mover, the air mover deactivation being for the extended time period. In some exemplary embodiments, the extended time period is approximately 10 minutes. In some exemplary embodiments, the extended time period of approximately 10 minutes includes the approximate 1-5 second delay.

In some exemplary embodiments, the air mover deactivation extended time period is approximately 3 to 30 minutes.

In some exemplary embodiments, at the time the conditioner initiator signals for conditioning termination, moisture is present on the cooling coil, a portion of such moisture being drainable from the cooling coil, the drainable moisture portion being drained during the extended period of time during substantially all of which the air mover is deactivated.

In some exemplary embodiments, the air mover first stage is predetermined at between approximately 15-45 seconds. In some exemplary embodiments, the air mover first stage is predetermined at between approximately 25-30 seconds. In some exemplary embodiments, the air mover second stage is predetermined at between approximately 20-240 seconds. In some exemplary embodiments, the air mover second stage is predetermined at between approximately 60-120 seconds.

In some exemplary embodiments, the method further comprises providing a microprocessor for enabling at least some of the method steps.

In some exemplary embodiments, the air mover is normally continuously activated, and responding to a conditioning initiation signal from the conditioner initiator such that the air mover is activated to the air mover first stage, further comprises overriding the continuous activation of the air mover.

In some exemplary embodiments, the method further comprises responding to a conditioning termination signal from the conditioner initiator by deactivating the compressor and causing the air mover to be deactivated for an extended time period, the method further comprising terminating the extended period of air mover deactivation as necessary to enable the air mover second stage following the air mover first stage in response to a conditioning initiation signal from the conditioner initiator.

In some exemplary embodiments, the air mover is a fan. In some exemplary embodiments, the conditioner initiator is a thermostat.

In some exemplary embodiments, at the time the conditioner initiator signals for conditioning initiation, moisture is present on the cooling coil, and during the air mover first and second stages, the air returning to the space is substantially free of such moisture.

In some exemplary embodiments, a heating coil is operatively connected with the air mover for passing air from a space across the heating coil to heat the air, then back into the space, and the method further comprises responding to a heat initiation signal from the conditioner initiator by activating the heating coil and air mover substantially simultaneously; and responding to a heat termination signal from the conditioner initiator by deactivating the heating coil and deactivating the air mover after a time delay of approximately 15-95 seconds.

In some exemplary embodiments, a reversing valve is operatively connected with the compressor, condenser, expansion device, cooling coil and the air mover, to function such that air is conditioned in a heat mode, the cooling coil being heated in such mode, and the method further comprises: alternately activating and deactivating the compressor and alternately activating and deactivating the air mover, the air mover comprising a heat mode first stage of zero speed, and a heat mode second stage of substantially full speed; responding to a heat conditioning initiation signal from the conditioner initiator such that the compressor is activated, the condenser is activated and the air mover begins the air mover heat mode first stage; and initiating the air mover second stage following the air mover first stage. In some exemplary embodiments, the air mover heat mode first stage is approximately 15-40 seconds. In some exemplary embodiments, the air mover heat mode first stage is approximately 25-30 seconds. In some exemplary embodiments, the method further comprises responding to a heat conditioning termination signal by deactivating the compressor and deactivating the air mover after a time delay of approximately 15-95 seconds.

In some exemplary embodiments of my invention I have provided a method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising: responding to a conditioning initiation signal from the conditioner initiator such that the compressor, condenser and air mover are functioning to cool the air; and responding to a conditioning termination signal from the conditioner initiator by deactivating the compressor, reducing the air mover speed for approximately 1-5 seconds beginning at the compressor deactivation, and then deactivating the air mover. In some exemplary embodiments, the air mover is normally continuously activated, and the air mover deactivation following the reduced air mover speed is for an extended time period.

In some exemplary embodiments of my invention I have provided a method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising: responding to a conditioning initiation signal from the conditioner initiator such that the compressor, condenser and air mover are functioning to cool the air; and responding to a conditioning termination signal from the conditioner initiator by deactivating the compressor and deactivating the air mover, the air mover deactivation being for an extended time period. In some exemplary embodiments, the air mover is normally continuously activated, and responding to a conditioning termination signal from the conditioner initiator further comprises reducing the air mover speed for approximately 1-5 seconds beginning at the compressor deactivation, prior to deactivating the air mover.

In some exemplary embodiments of my invention I have provided a method of conditioning the air in a space, wherein a compressor, a condenser, an expansion device, a reversing valve, and a cooling coil are provided and operatively connected to function such that air is conditioned in a heat mode, the cooling coil being heated in such mode, wherein an air mover is provided for passing air from a space across the cooling coil to warm the air, then back into the space, and further wherein conditioning is initiated and terminated in response to signals from a conditioner initiator, the method comprising: alternately activating and deactivating the compressor and alternately activating and deactivating the air mover, the air mover comprising a heat mode first stage of zero speed, and a heat mode second stage of substantially full speed; responding to a heat initiation signal from the conditioner initiator such that the compressor is activated, the condenser is activated and the air mover begins the air mover heat mode first stage; and initiating the air mover heat mode second stage following the air mover heat mode first stage. In some exemplary embodiments, the air mover heat mode first stage is approximately 15-40 seconds. In some exemplary embodiments, the air mover heat mode first stage is approximately 25-30 seconds. In some exemplary embodiments, the method further comprises responding to a heat conditioning termination signal by deactivating the compressor and deactivating the air mover after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: means providing electronic circuitry for alternately activating and deactivating the compressor and alternately activating and deactivating the air mover, the air mover activation comprising a first stage of zero speed, a second stage of reduced speed, and a third stage of substantially full speed; the means further providing electronic circuitry such that in response to a conditioning initiation signal from the conditioner initiator, the compressor is activated, the condenser is activated and the air mover begins the air mover first stage; the means further providing electronic circuitry such that the air mover second stage is initiated following the air mover first stage; and the means further providing electronic circuitry such that the air mover third stage is initiated following the air mover second stage.

In some exemplary embodiments, the controller further comprises means providing electronic circuitry such that the system responds to a conditioning termination signal from the conditioner initiator such that the compressor and the air mover are simultaneously deactivated. In some exemplary embodiments, the controller further comprises means providing electronic circuitry such that in response to a conditioning termination signal from the conditioner initiator the compressor is deactivated, the air mover speed is reduced for approximately 1-5 seconds beginning at the compressor deactivation, and then the air mover is deactivated. In some exemplary embodiments, the system air mover is normally continuously activated, and the controller further comprises means providing electronic circuitry such that in response to a conditioning termination signal from the conditioner initiator the compressor is deactivated and the air mover is deactivated, the air mover deactivation being for an extended time period.

In some exemplary embodiments, the controller further comprises means providing electronic circuitry such that in response to the conditioning termination signal from the conditioner initiator further comprises the compressor is deactivated, the air mover speed is reduced for approximately 1-5 seconds beginning at the compressor deactivation, and the air mover is deactivated, the air mover deactivation being for the extended time period. In some exemplary embodiments, the extended time period is approximately 10 minutes. In some exemplary embodiments, the extended time period of approximately 10 minutes includes the approximate 1-5 second delay.

In some exemplary embodiments, the air mover deactivation extended time period is approximately 3 to 30 minutes. In some exemplary embodiments, the air mover deactivation extended time period is approximately 10 minutes. In some exemplary embodiments, at the time the conditioner initiator signals for conditioning termination, moisture is present on the cooling coil, a portion of such moisture being drainable from the cooling coil, the drainable moisture portion being drained during the extended period of time during substantially all of which the air mover is deactivated.

In some exemplary embodiments, the air mover first stage is predetermined at between approximately 15-45 seconds. In some exemplary embodiments, the air mover first stage is predetermined at between approximately 25-30 seconds. In some exemplary embodiments, the air mover second stage is predetermined at between approximately 20-240 seconds. In some exemplary embodiments, the air mover second stage is predetermined at between approximately 60-120 seconds.

In some exemplary embodiments, the system air mover is normally continuously activated, and the means providing electronic circuitry such that in response to a conditioning initiation signal from the conditioner initiator the compressor is activated, the condenser is activated and the air mover is activated to the air mover first stage, further comprises means providing electronic circuitry such that the continuous activation of the air mover is overridden.

In some exemplary embodiments, the controller further comprises means providing electronic circuitry such that in response to a conditioning termination signal from the conditioner initiator the compressor is deactivated and the air mover is deactivated for an extended time period, and the controller further comprises means providing electronic circuitry such that the extended period of air mover deactivation is terminated as necessary to enable the air mover second stage following the air mover first stage in response to a conditioning initiation signal from the conditioner initiator.

In some exemplary embodiments, the air mover is a fan. In some exemplary embodiments, the conditioner initiator is a thermostat.

In some exemplary embodiments, at the time the conditioner initiator signals for conditioning initiation, moisture is present on the cooling coil, and during the air mover first and second stages, the air returning to the space is substantially free of such moisture.

In some exemplary embodiments, the system further includes a heating coil, the heating coil being operatively connected with the air mover for passing air from a space across the heating coil to heat the air, then back into the space, and the controller further comprises: means providing electronic circuitry such that in response to a heat initiation signal from the conditioner initiator the heating coil and air mover are activated substantially simultaneously; and means providing electronic circuitry such that in response to a heat termination signal from the conditioner initiator the heating coil is deactivated and the air mover is deactivated after a time delay of approximately 15-95 seconds.

In some exemplary embodiments, the system further includes a reversing valve, the reversing valve being operatively connected with the compressor, condenser, expansion device, cooling coil and the air mover, to function such that air is conditioned in a heat mode, the cooling coil being heated in such mode, and the controller further comprises: means providing electronic circuitry for alternately activating and deactivating the compressor and alternately activating and deactivating the air mover, the air mover activation comprising a heat mode first stage of zero speed, and a heat mode second stage of substantially full speed; the means further providing electronic circuitry such that in response to a heat conditioning initiation signal from the conditioner initiator the compressor is activated, the condenser is activated and the air mover begins the air mover heat mode first stage; and the means further providing electronic circuitry such that the air mover second stage is initiated following the air mover first stage.

In some exemplary embodiments, the air mover heat mode first stage is approximately 15-40 seconds. In some exemplary embodiments, the air mover heat mode first stage is approximately 25-30 seconds. In some exemplary embodiments, the controller further comprises means providing electronic circuitry such that in response to a heat conditioning termination signal the compressor is deactivated and the air mover is deactivated after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from a space across the cooling coil to cool and dehumidify the air, then back into the space, and further wherein conditioning is initiated and terminated in response to signals from a conditioner initiator, the controller comprising means for: responding to a conditioning initiation signal from the conditioner initiator such that the compressor, condenser and air mover are functioning to cool the air; and responding to a conditioning termination signal from the conditioner initiator by deactivating the compressor, reducing the air mover speed for approximately 1-5 seconds beginning at the compressor deactivation, and then deactivating the air mover. In some exemplary embodiments, the air mover is normally continuously activated, and the air mover deactivation following the reduced air mover speed is for an extended time period.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from a space across the cooling coil to cool and dehumidify the air, then back into the space, and further wherein conditioning is initiated and terminated in response to signals from a conditioner initiator, the controller comprising means for: responding to a conditioning initiation signal from the conditioner initiator such that the compressor, condenser and air mover are functioning to cool the air; and responding to a conditioning termination signal from the conditioner initiator by deactivating the compressor and deactivating the air mover, the air mover deactivation being for an extended time period. In some exemplary embodiments, the air mover is normally continuously activated, and the means for responding to a conditioning termination signal from the conditioner initiator further comprises means for reducing the air mover speed for approximately 1-5 seconds beginning at the compressor deactivation, prior to deactivating the air mover.

In some exemplary embodiments of my invention I have provided a controller for controlling a system for conditioning the air in a space, wherein a compressor, a condenser, an expansion device, a reversing valve, and a cooling coil are provided and operatively connected to function such that air is conditioned in a heat mode, the cooling coil being heated in such mode, wherein an air mover is provided for passing air from a space across the cooling coil to warm the air, then back into the space, and further wherein conditioning is initiated and terminated in response to signals from a conditioner initiator, the controller comprising means for: alternately activating and deactivating the compressor and alternately activating and deactivating the air mover, the air mover comprising a heat mode first stage of zero speed, and a heat mode second stage of substantially full speed; responding to a heat initiation signal from the conditioner initiator such that the compressor is activated, the condenser is activated and the air mover begins the air mover heat mode first stage; and initiating the air mover heat mode second stage following the air mover heat mode first stage. In some exemplary embodiments, the air mover heat mode first stage is approximately 15-40 seconds. In some exemplary embodiments, the air mover heat mode first stage is approximately 25-30 seconds. In some exemplary embodiments, the controller further comprises means for responding to a heat conditioning termination signal by deactivating the compressor and deactivating the air mover after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: electronic circuitry means for responding to a conditioning initiation signal from the conditioner initiator such that the compressor, condenser and air mover are functioning to cool the air; and electronic circuitry means for responding to a conditioning termination signal from the conditioner initiator by deactivating the compressor, reducing the air mover speed for approximately 1-5 seconds beginning at the compressor deactivation, and then deactivating the air mover. In some exemplary embodiments, the air mover is normally continuously activated, and the air mover deactivation following the reduced air mover speed is for an extended time period.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: electronic circuitry means for responding to a conditioning initiation signal from the conditioner initiator such that the compressor, condenser and air mover are functioning to cool the air; and electronic circuitry means for responding to a conditioning termination signal from the conditioner initiator by deactivating the compressor and deactivating the air mover, the air mover deactivation being for an extended time period. In some exemplary embodiments, the air mover is normally continuously activated, and the electronic circuitry means for responding to a conditioning termination signal from the conditioner initiator further comprises electronic circuitry means for reducing the air mover speed for approximately 1-5 seconds beginning at the compressor deactivation, prior to deactivating the air mover.

In some exemplary embodiments of my invention I have provided a controller for controlling a system for conditioning the air in a space, wherein a compressor, a condenser, an expansion device, a reversing valve, and a cooling coil are provided and operatively connected to function such that air is conditioned in a heat mode, the cooling coil being heated in such mode, wherein an air mover is provided for passing air from the space across the cooling coil to warm the air, then back into the space, and further wherein conditioning is initiated and terminated in response to signals from a conditioner initiator, the controller comprising: electronic circuitry means for alternately activating and deactivating the compressor and alternately activating and deactivating the air mover, the air mover comprising a heat mode first stage of zero speed, and a heat mode second stage of substantially full speed; electronic circuitry means for responding to a heat initiation signal from the conditioner initiator such that the compressor is activated, the condenser is activated and the air mover begins the air mover heat mode first stage; and electronic circuitry means for initiating the air mover heat mode second stage following the air mover heat mode first stage. In some exemplary embodiments, the air mover heat mode first stage is approximately 15-40 seconds. In some exemplary embodiments, the air mover heat mode first stage is approximately 25-30 seconds. In some exemplary embodiments, the controller further comprises responding to a heat conditioning termination signal by deactivating the compressor and deactivating the air mover after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: electronic circuitry for alternately activating and deactivating the compressor and alternately activating and deactivating the air mover, the air mover activation comprising a first stage of zero speed, a second stage of reduced speed, and a third stage of substantially full speed, the electronic circuitry being configured such that; in response to a conditioning initiation signal from the conditioner initiator, the compressor is activated, the condenser is activated and the air mover begins the air mover first stage; the air mover second stage is initiated following the air mover first stage; and the air mover third stage is initiated following the air mover second stage.

In some exemplary embodiments the controller further comprises electronic circuitry configured such that the system responds to a conditioning termination signal from the conditioner initiator such that the compressor and the air mover are simultaneously deactivated.

In some exemplary embodiments the controller further comprises electronic circuitry configured such that in response to a conditioning termination signal from the conditioner initiator the compressor is deactivated, the air mover speed is reduced for approximately 1-5 seconds beginning at the compressor deactivation, and then the air mover is deactivated.

In some exemplary embodiments the system air mover is normally continuously activated, and the controller further comprises electronic circuitry configured such that in response to a conditioning termination signal from the conditioner initiator the compressor is deactivated and the air mover is deactivated, the air mover deactivation being for an extended time period. In some exemplary embodiments the controller further comprises electronic circuitry configured such that in response to the conditioning termination signal from the conditioner initiator further comprises the compressor is deactivated, the air mover speed is reduced for approximately 1-5 seconds beginning at the compressor deactivation, and the air mover is deactivated, the air mover deactivation being for the extended time period. In some exemplary embodiments the extended time period is approximately 10 minutes. In some exemplary embodiments the extended time period of approximately 10 minutes includes the approximate 1-5 second delay.

In some exemplary embodiments the air mover deactivation extended time period is approximately 3 to 30 minutes. In some exemplary embodiments the air mover deactivation extended time period is approximately 10 minutes. In some exemplary embodiments at the time the conditioner initiator signals for conditioning termination, moisture is present on the cooling coil, a portion of such moisture being drainable from the cooling coil, the drainable moisture portion being drained during the extended period of time during substantially all of which the air mover is deactivated.

In some exemplary embodiments the air mover first stage is predetermined at between approximately 15-45 seconds. In some exemplary embodiments the air mover first stage is predetermined at between approximately 25-30 seconds. In some exemplary embodiments the air mover second stage is predetermined at between approximately 20-240 seconds. In some exemplary embodiments the air mover second stage is predetermined at between approximately 60-120 seconds.

In some exemplary embodiments the system air mover is normally continuously activated, and the electronic circuitry is configured such that in response to a conditioning initiation signal from the conditioner initiator the compressor is activated, the condenser is activated and the air mover begins the air mover first stage, and the controller further comprises electronic circuitry configured such that the continuous activation of the air mover is overridden.

In some exemplary embodiments the controller further comprises electronic circuitry configured such that in response to a conditioning termination signal from the conditioner initiator the compressor is deactivated and the air mover is deactivated for an extended time period, and the controller further comprises electronic circuitry configured such that the extended period of air mover deactivation is terminated as necessary to enable the air mover second stage following the air mover first stage in response to a conditioning initiation signal from the conditioner initiator.

In some exemplary embodiments the air mover is a fan. In some exemplary embodiments the conditioner initiator is a thermostat.

In some exemplary embodiments the time the conditioner initiator signals for conditioning initiation, moisture is present on the cooling coil, and during the air mover first and second stages, the air returning to the space is substantially free of such moisture.

In some exemplary embodiments the system further includes a heating coil, the heating coil being operatively connected with the air mover for passing air from a space across the heating coil to heat the air, then back into the space, the controller further comprising: electronic circuitry configured such that in response to a heat initiation signal from the conditioner initiator the heating coil and air mover are activated substantially simultaneously; and electronic circuitry configured such that in response to a heat termination signal from the conditioner initiator the heating coil is deactivated and the air mover is deactivated after a time delay of approximately 15-95 seconds.

In some exemplary embodiments the system further includes a reversing valve, the reversing valve being operatively connected with the compressor, condenser, expansion device, cooling coil and the air mover, to function such that air is conditioned in a heat mode, the cooling coil being heated in such mode, and the controller further comprises: electronic circuitry for alternately activating and deactivating the compressor and alternately activating and deactivating the air mover, the air mover comprising a heat mode first stage of zero speed, and a heat mode second stage of substantially full speed; electronic circuitry configured such that in response to a heat conditioning initiation signal from the conditioner initiator the compressor is activated, the condenser is activated and the air mover begins the air mover heat mode first stage; and the electronic circuitry being further configured such that the air mover second stage is initiated following the air mover first stage. In some exemplary embodiments the air mover heat mode first stage is approximately 15-40 seconds. In some exemplary embodiments the air mover heat mode first stage is approximately 25-30 seconds. In some exemplary embodiments the electronic circuitry is further configured for providing electronic circuitry such that in response to a heat conditioning termination signal the compressor is deactivated and the air mover is deactivated after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: electronic circuitry for responding to a conditioning initiation signal from the conditioner initiator such that the compressor, condenser and air mover are functioning to cool the air; and electronic circuitry for responding to a conditioning termination signal from the conditioner initiator by deactivating the compressor, reducing the air mover speed for approximately 1-5 seconds beginning at the compressor deactivation, and then deactivating the air mover. In some exemplary embodiments the air mover is normally continuously activated, and the air mover deactivation following the reduced air mover speed is for an extended time period.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: electronic circuitry for responding to a conditioning initiation signal from the conditioner initiator such that the compressor, condenser and air mover are functioning to cool the air; and electronic circuitry for responding to a conditioning termination signal from the conditioner initiator by deactivating the compressor and deactivating the air mover, the air mover deactivation being for an extended time period. In some exemplary embodiments the air mover is normally continuously activated, and the electronic circuitry for responding to a conditioning termination signal from the conditioner initiator further comprises electronic circuitry for reducing the air mover speed for approximately 1-5 seconds beginning at the compressor deactivation, prior to deactivating the air mover.

In some exemplary embodiments of my invention I have provided a controller for controlling a system for conditioning the air in a space, wherein a compressor, a condenser, an expansion device, a reversing valve, and a cooling coil are provided and operatively connected to function such that air is conditioned in a heat mode, the cooling coil being heated in such mode, wherein an air mover is provided for passing air from the space across the cooling coil to warm the air, then back into the space, and further wherein conditioning is initiated and terminated in response to signals from a conditioner initiator, the controller comprising: electronic circuitry for alternately activating and deactivating the compressor and alternately activating and deactivating the air mover, the air mover comprising a heat mode first stage of zero speed, and a heat mode second stage of substantially full speed; electronic circuitry responding to a heat initiation signal from the conditioner initiator such that the compressor is activated, the condenser is activated and the air mover begins the air mover heat mode first stage; and electronic circuitry initiating the air mover heat mode second stage following the air mover heat mode first stage. In some exemplary embodiments the air mover heat mode first stage is approximately 15-40 seconds. In some exemplary embodiments the air mover heat mode first stage is approximately 25-30 seconds. In some exemplary embodiments the controller further comprises responding to a heat conditioning termination signal by deactivating the compressor and deactivating the air mover after a time delay of approximately 15-95 seconds.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: first terminal set means having a plurality of terminals for electronic communication with the conditioner initiator such that one or more of the terminals are alternately energized and de-energized; a second terminal set means having a plurality of terminals for alternately activating and deactivating the compressor, the condenser and the air mover, the air mover being activatable at a reduced speed and a normal speed; electronic circuitry means for relaying and enabling selective and delayable electronic communications between at least some of the first terminal set means terminals and at least some of the second terminal set means terminals; wherein in response to a conditioning initiation signal from the conditioner initiator: the compressor is activated, the condenser is activated and the air mover begins an air mover first stage wherein the air mover is operating at zero speed; an air mover second stage is initiated following the air mover first stage, wherein the air mover is activated at a reduced speed; and an air mover third stage is initiated following the air mover second stage, wherein the air mover speed is activated at normal speed.

In some exemplary embodiments in response to a conditioning termination signal from the conditioner initiator, the compressor is deactivated, the air mover speed is reduced for approximately 1-5 seconds beginning at the compressor deactivation, and the air mover is then deactivated.

In some exemplary embodiments the system air mover is normally continuously activated, and in response to a conditioning termination signal from the conditioner initiator, the compressor is deactivated and the air mover is deactivated for an extended time period. In some exemplary embodiments, in response to a conditioning termination signal from the conditioner initiator, the compressor is deactivated, the air mover speed is reduced for approximately 1-5 seconds beginning at the compressor deactivation, and then deactivated, the air mover deactivation being for the extended time period.

In some exemplary embodiments a heating coil is operatively connected with the air mover for passing air from a space across the heating coil to heat the air, then back into the space, and the circuitry means is further configured such that: in response to a heat initiation signal from the conditioner initiator the heating coil and air mover are substantially simultaneously activated; and in response to a heat termination signal from the conditioner initiator the heating coil is deactivated and the air mover is deactivated after a time delay of approximately 15-95 seconds.

In some exemplary embodiments a reversing valve is operatively connected with the compressor, condenser, expansion device, cooling coil and the air mover, to function such that air is conditioned in a heat mode, the cooling coil being heated in such mode, and the circuitry means is further configured: for alternately activating and deactivating the compressor and alternately activating and deactivating the air mover, the air mover activation comprising a heat mode first stage of zero speed, and a heat mode second stage of substantially full speed; such that in response to a heat conditioning initiation signal from the conditioner initiator the compressor is activated, the condenser is activated and the air mover is activated to the air mover heat mode first stage; and the air mover second stage is initiated following the air mover first stage.

In some exemplary embodiments the first terminal set means plurality of terminals includes at least a C-In terminal, an R-In terminal, a Y-In terminal, and a G-In terminal; the second terminal set means plurality of terminals includes at least a C-Out terminal, an R-Out terminal, a Y-Cond terminal, a G-Low terminal, and a G-High terminal; the circuitry means for relaying and enabling selective and delayable electronic communications being configured such that: the R-In, R-Out, C-In, and C-Out terminals are configured to enable electric power distribution within the controller and in cooperation with the system; the G-In and G-Low terminals are energizable for activation and deactivation of the air mover at a reduced speed, such that when the G-In and G-Low terminals are energized the air mover is activated at reduced speed, and further such that when the G-In and G-Low terminals are not energized the air mover is off; the G-In, G-Low, and G-High terminals are energizable for activation and deactivation of the air mover at normal speed, such that when the G-In, G-Low, and G-High terminals are energized the air mover is activated at normal speed, and further such that when the G-In, G-Low and G-High terminals are not energized the fan is off; the Y-In and Y-Cond terminals are energizable for activation and deactivation of the condenser, such that when the Y-In and Y-Cond terminals are energized the condenser is activated, and further such that when the Y-In and Y-Cond terminals are not energized, the condenser is deactivated; and the circuitry means further comprising a first time delay means and a second time delay means, the first time delay means delaying the energization of the G-Low terminal for the duration of the air mover first stage, the second time delay means delaying the energization of the G-High terminal for the duration of the air mover second stage.

In some exemplary embodiments the first terminal set means plurality of terminals further comprises an O-In terminal, the O-In terminal being configured and energizable for communicating with the circuitry means as to whether the conditioner initiator request is for cooling or for heating.

In some exemplary embodiments the circuitry means further comprises: means for adjusting the duration of the first time delay means; and means for adjusting the duration of the second time delay means.

In some exemplary embodiments the circuitry means further comprises a microprocessor programmed for controlling the first and second time delay means.

In some exemplary embodiments the controller further comprises the air mover is continuously activated, and, in response to a conditioning termination signal from the conditioner initiator, the Y-In and Y-Cond terminals are de-energized, causing condenser and compressor deactivation, and the G-High terminal is de-energized, causing reduced air mover speed, and the G-Low terminal is de-energized, causing air mover deactivation, then re-energized, causing air mover activation at reduced speed, the circuitry means further comprising a third time delay means and a fourth time delay means, the third time delay means delaying the de-energization of the G-Low terminal for approximately 1-5 seconds beginning at the compressor deactivation, the fourth time delay means delaying the re-energization of the G-Low terminal for an extended time period. In some exemplary embodiments the air mover is activated, and in response to a conditioning initiation signal from the conditioner initiator the G-Low terminal is deactivated, causing air mover deactivation for the duration of the air mover first stage. In some exemplary embodiments the circuitry means further comprises a microprocessor programmed for controlling the first, second, third, and fourth time delay means.

In some exemplary embodiments the air mover is not continuously activated, and, in response to a conditioning termination signal from the conditioner initiator, the Y-In and Y-Cond terminals are de-energized, causing condenser and compressor deactivation, and the G-High terminal is de-energized, causing reduced air mover speed, and the G-In and G-Low terminals are de-energized, causing air mover deactivation, the circuitry means further comprising a third time delay means and a fourth time delay means, the third time delay means delaying the de-energization of the G-Low terminal for approximately 1-5 seconds beginning at the compressor deactivation, the fourth time delay means delaying the energization of the G-Low terminal for an extended time period. In some exemplary embodiments the circuitry means is further configured such that, in response to a conditioning initiation signal during the extended time period, the fourth time delay means is terminated, causing the termination of the extended time period of air mover deactivation, as necessary to enable the air mover second stage following the air mover first stage in response to such conditioning initiation signal from the conditioner initiator.

In some exemplary embodiments a heating coil is operatively connected with the air mover for passing air from a space across the heating coil to heat the air, then back into the space, and: the first terminal set means plurality of terminals further includes a W-In terminal; and the second terminal set means plurality of terminals further includes a W-Out terminal; the circuitry means being further configured such that the W-In and W-Out terminals are energizable for activation of the heating coil, such that when the W-In and W-Out terminals are energized the heating coil is activated, and further such that when the W-In and W-Out are not energized, the heating coil is not activated; the circuitry means being still further configured such that: in response to a heat initiation signal from the conditioner initiator, the heating coil and air mover are substantially simultaneously activated: in response to a heat termination signal from the conditioner initiator, the heating coil is deactivated and the air mover is deactivated; the circuitry means further comprising a fifth time delay means, the fifth time delay means delaying the air mover deactivation for approximately 15-95 seconds.

In some exemplary embodiments a reversing valve is operatively connected with the compressor, condenser, expansion device, cooling coil and the air mover, to function such that air is conditioned in a heat mode, the cooling coil being heated in such mode, and the circuitry means is further configured: for alternately activating and deactivating the compressor and alternately activating and deactivating the air mover, the air mover activation comprising a heat mode first stage of zero speed, and a heat mode second stage of substantially full speed; and such that, in response to a heat conditioning initiation signal from the conditioner initiator: the Y-In terminal and the Y-Cond terminal are energized such that the condenser and compressor are activated, the G-In terminal is energized, and the first time delay means is initiated, causing the air mover heat mode first stage to begin with no air mover activation; and the G-Low terminal and the G-High terminal are energized, causing the air mover second stage to begin following the air mover first stage, the G-Low terminal and the G-High terminal energization being delayed by the first time delay means for the duration of the air mover first stage. In some exemplary embodiments the circuitry means is further configured such that, in response to a heat conditioning termination signal from the conditioner initiator, the Y-In terminal, the G-In terminal, and the G-High terminal, are de-energized, causing the compressor and condenser to deactivate and the air mover speed to be reduced, and the fifth time delay means is initiated, the G-Low terminal being de-energized at the end of the fifth time delay means period, the first time delay means period being approximately 15-95 seconds. In some exemplary embodiments the circuitry means further comprises a microprocessor programmed for controlling the first and fifth time delay means.

In some exemplary embodiments of my invention I have provided a controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising: a first terminal set having a plurality of terminals for electronic communication with the conditioner initiator such that one or more of the terminals are alternately energized and de-energized; a second terminal set having a plurality of terminals for alternately activating and deactivating the compressor, the condenser and the air mover, the air mover being activatable at a reduced speed and a normal speed; electronic circuitry for relaying and enabling selective and delayable electronic communications between at least some of the first terminal set terminals and at least some of the second terminal set terminals; wherein in response to a conditioning initiation signal from the conditioner initiator: the compressor is activated, the condenser is activated and the air mover begins an air mover first stage wherein the air mover is operating at zero speed; an air mover second stage is initiated following the air mover first stage, wherein the air mover is activated at a reduced speed; and an air mover third stage is initiated following the air mover second stage, wherein the air mover speed is activated at normal speed.

In some exemplary embodiments, in response to a conditioning termination signal from the conditioner initiator, the compressor is deactivated, the air mover speed is reduced for approximately 1-5 seconds beginning at the compressor deactivation, and the air mover is then deactivated.

In some exemplary embodiments the system air mover is normally continuously activated, and, in response to a conditioning termination signal from the conditioner initiator, the compressor is deactivated and the air mover is deactivated for an extended time period. In some exemplary embodiments, in response to a conditioning termination signal from the conditioner initiator, the compressor is deactivated, the air mover speed is reduced for approximately 1-5 seconds beginning at the compressor deactivation, and then deactivated, the air mover deactivation being for the extended time period.

In some exemplary embodiments a heating coil is operatively connected with the air mover for passing air from a space across the heating coil to heat the air, then back into the space, and the circuitry is further configured such that: in response to a heat initiation signal from the conditioner initiator the heating coil and air mover are substantially simultaneously activated; and in response to a heat termination signal from the conditioner initiator the heating coil is deactivated and the air mover is deactivated after a time delay of approximately 15-95 seconds.

In some exemplary embodiments a reversing valve is operatively connected with the compressor, condenser, expansion device, cooling coil and the air mover, to function such that air is conditioned in a heat mode, the cooling coil being heated in such mode, and the circuitry is further configured: for alternately activating and deactivating the compressor and alternately activating and deactivating the air mover, the air mover activation comprising a heat mode first stage of zero speed, and a heat mode second stage of substantially full speed; such that in response to a heat conditioning initiation signal from the conditioner initiator the compressor is activated, the condenser is activated and the air mover is activated to the air mover heat mode first stage; and the air mover second stage is initiated following the air mover first stage.

In some exemplary embodiments the first terminal set plurality of terminals includes at least a C-In terminal, an R-In terminal, a Y-In terminal, and a G-In terminal; the second terminal set plurality of terminals includes at least a C-Out terminal, an R-Out terminal, a Y-Cond terminal, a G-Low terminal, and a G-High terminal; the circuitry for relaying and enabling selective and delayable electronic communications being configured such that: the R-In, R-Out, C-In, and C-Out terminals are configured to enable electric power distribution within the controller and in cooperation with the system; the G-In and G-Low terminals are energizable for activation and deactivation of the air mover at a reduced speed, such that when the G-In and G-Low terminals are energized the air mover is activated at reduced speed, and further such that when the G-In and G-Low terminals are not energized the air mover is off; the G-In, G-Low, and G-High terminals are energizable for activation and deactivation of the air mover at normal speed, such that when the G-In, G-Low, and G-High terminals are energized the air mover is activated at normal speed, and further such that when the G-In, G-Low and G-High terminals are not energized the fan is off; the Y-In and Y-Cond terminals are energizable for activation and deactivation of the condenser, such that when the Y-In and Y-Cond terminals are energized the condenser is activated, and further such that when the Y-In and Y-Cond terminals are not energized, the condenser is deactivated; and the circuitry further comprising a first time delay and a second time delay, the first time delay delaying the energization of the G-Low terminal for the duration of the air mover first stage, the second time delay delaying the energization of the G-High terminal for the duration of the air mover second stage.

In some exemplary embodiments the first terminal set plurality of terminals further comprises an O-In terminal, the O-In terminal being configured and energizable for communicating with the circuitry as to whether the conditioner initiator request is for cooling or for heating.

In some exemplary embodiments the duration of the first time delay is adjustable and the duration of the second time delay is adjustable.

In some exemplary embodiments the circuitry further comprises a microprocessor programmed for controlling the first and second time delays.

In some exemplary embodiments the air mover is continuously activated, and, in response to a conditioning termination signal from the conditioner initiator, the Y-In and Y-Cond terminals are de-energized, causing condenser and compressor deactivation, and the G-High terminal is de-energized, causing reduced air mover speed, and the G-Low terminal is de-energized, causing air mover deactivation, then re-energized, causing air mover activation at reduced speed, the circuitry further comprising a third time delay and a fourth time delay, the third time delay delaying the de-energization of the G-Low terminal for approximately 1-5 seconds beginning at the compressor deactivation, the fourth time delay delaying the re-energization of the G-Low terminal for an extended time period. In some exemplary embodiments the air mover is activated, and in response to a conditioning initiation signal from the conditioner initiator the G-Low terminal is deactivated, causing air mover deactivation for the duration of the air mover first stage. In some exemplary embodiments the circuitry further comprises a microprocessor programmed for controlling the first, second, third, and fourth time delays.

In some exemplary embodiments the air mover is not continuously activated, and, in response to a conditioning termination signal from the conditioner initiator, the Y-In and Y-Cond terminals are de-energized, causing condenser and compressor deactivation, and the G-High terminal is de-energized, causing reduced air mover speed, and the G-In and G-Low terminals are de-energized, causing air mover deactivation, the circuitry further comprising a third time delay and a fourth time delay, the third time delay delaying the de-energization of the G-Low terminal for approximately 1-5 seconds beginning at the compressor deactivation, the fourth time delay delaying the energization of the G-Low terminal for an extended time period. In some exemplary the circuitry is further configured such that, in response to a conditioning initiation signal during the extended time period, the fourth time delay is terminated, causing the termination of the extended time period of air mover deactivation, as necessary to enable the air mover second stage following the air mover first stage in response to such conditioning initiation signal from the conditioner initiator.

In some exemplary embodiments a heating coil is operatively connected with the air mover for passing air from a space across the heating coil to heat the air, then back into the space, and: the first terminal set plurality of terminals further includes a W-In terminal; and the second terminal set plurality of terminals further includes a W-Out terminal; the circuitry being further configured such that the W-In and W-Out terminals are energizable for activation of the heating coil, such that when the W-In and W-Out terminals are energized the heating coil is activated, and further such that when the W-In and W-Out are not energized, the heating coil is not activated; the circuitry being still further configured such that: in response to a heat initiation signal from the conditioner initiator, the heating coil and air mover are substantially simultaneously activated: in response to a heat termination signal from the conditioner initiator, the heating coil is deactivated and the air mover is deactivated; the circuitry further comprising a fifth time delay, the fifth time delay delaying the air mover deactivation for approximately 15-95 seconds.

In some exemplary embodiments a reversing valve is operatively connected with the compressor, condenser, expansion device, cooling coil and the air mover, to function such that air is conditioned in a heat mode, the cooling coil being heated in such mode, and the circuitry is further configured: for alternately activating and deactivating the compressor and alternately activating and deactivating the air mover, the air mover activation comprising a heat mode first stage of zero speed, and a heat mode second stage of substantially full speed; and such that, in response to a heat conditioning initiation signal from the conditioner initiator: the Y-In terminal and the Y-Cond terminal are energized such that the condenser and compressor are activated, the G-In terminal is energized, and the first time delay is initiated, causing the air mover heat mode first stage to begin with no air mover activation; and the G-Low terminal and the G-High terminal are energized, causing the air mover second stage to begin following the air mover first stage, the G-Low terminal and the G-High terminal energization being delayed by the first time delay for the duration of the air mover first stage. In some exemplary embodiments the circuitry is further configured such that, in response to a heat conditioning termination signal from the conditioner initiator, the Y-In terminal, the G-In terminal, and the G-High terminal, are de-energized, causing the compressor and condenser to deactivate and the air mover speed to be reduced, and the fifth time delay is initiated, the G-Low terminal being de-energized at the end of the fifth time delay period, the first time delay period being approximately 15-95 seconds. In some exemplary embodiments the circuitry further comprises a microprocessor programmed for controlling the first and fifth time delays.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a partial schematic of an exemplary embodiment of the present invention.

FIG. 2 is a flow chart representating an exemplary embodiment of the present invention.

FIG. 3 is a timeline depiction of the exemplary embodiment of the present invention depicted in FIG. 2.

FIG. 4 is a data plot (room relative humidity vs. time) of data acquired during a test of an air conditioning system both with an exemplary embodiment of the present invention and without.

FIG. 5 is a data plot (cooling coil temperature vs. time) of data acquired during a test of an air conditioning system both with an exemplary embodiment of the present invention and without.

FIG. 6 is a data plot (immediately after cooling coil relative humidity vs. time) of data acquired during a test of an air conditioning system both with an exemplary embodiment of the present invention and without.

FIG. 7 is a flow chart representating an exemplary embodiment of the present invention.

FIG. 8 is a timeline depiction of the exemplary embodiment of the present invention depicted in FIG. 7.

FIG. 9 is a timeline representation of an exemplary embodiment of the present invention.

FIG. 10 is a partial schematic of an exemplary embodiment of the present invention.

FIG. 11 is a flow chart representating an exemplary embodiment of the present invention.

FIG. 12 is a timeline depiction of the exemplary embodiment of the present invention depicted in FIG. 11.

FIG. 13 is a flow chart representating an exemplary embodiment of the present invention.

FIG. 14 is a timeline depiction of the exemplary embodiment of the present invention depicted in FIG. 13.

FIG. 15 is a flow chart representating an exemplary embodiment of the present invention.

FIG. 16 is a timeline depiction of the exemplary embodiment of the present invention depicted in FIG. 15.

FIG. 17 is a flow chart representating an exemplary embodiment of the present invention.

FIG. 18 is a timeline depiction of the exemplary embodiment of the present invention depicted in FIG. 17.

FIG. 19 is a symbolic wiring diagram of an installation of the device of the present invention in a non-heat pump residential air conditioning system.

### DETAILED DESCRIPTION OF EXEMPLARY EMBODIMENTS

The following discussion describes exemplary embodiments of the invention in detail. This discussion should not be construed, however, as limiting the invention to those particular embodiments. Practitioners skilled in the art will recognize numerous other embodiments as well.

### DEFINITIONS

The term “conditioner initiator,” as used herein, refers to any of several devices and/or configurations that initiate and/or terminate cooling and/or heating cycles by air conditioning systems, including, but not limited to, thermostats, computer based devices programmed to initiate/terminate such cycles, wireless assemblies for receiving input from remote devices, timers, and the like, some of which respond to temperature changes, others to instant commands, and others in response to pre-set and/or programmed time intervals. Exemplary embodiments of the present invention discussed herein are generally described with reference to a conventional thermostat, although the use of other conditioner initiators is contemplated and will be apparent to a person of ordinary skill in the art upon reading the disclosures herein.

Similarly, the terms “conditioning initiation signal” and “conditioning termination signal,” as used herein, refers to the means, usually an electric signal, for requesting the start and/or termination of the air conditioning system cooling cycle and/or heating cycle. Exemplary embodiments of the present invention discussed herein are generally described with reference to the device receiving a request to start or terminate cooling or heating. In some instances, a thermostat and/or other conditioner initiator will have a user-operated setting of “COOL” and a starting temperature setting which, when room temperature reaches such a setting from a cooler temperature, will cause the thermostat to send a conditioning initiation signal to start a cooling cycle. Similarly, such a conditioner initiator will often include a user-operated setting of “HEAT” which, when room temperature reaches such a setting from a warmer temperature, will cause the thermostat to send a conditioning initiation signal to start a heating cycle.

The term “air mover,” as used herein, refers to a fan, blower, or other such equipment typically used in air conditioning systems for moving air across an inside coil and/or a heating coil. In descriptions of exemplary embodiments below, the words “fan” and “blower” are used frequently.

The term “normally continuously activated,” as used herein, refers to air conditioning systems that have been set, typically through a setting on the thermostat or other conditioner initiator, to have the fan run continuously between cooling cycles, i.e. a continuous fan mode. In some instances a thermostat will have a “FAN ON” setting establishing this continuous activation, and conversely will have a “FAN AUTO” setting such that the fan is not continuously activated between cooling cycles.

A “heat pump,” as used herein, refers to an air conditioning system that includes a reversing valve allowing the system to be used for both heating, where an inside coil heats passing air, and for cooling, where an inside coil cools passing air.

The terms “substantially full speed,” “full speed,” “normal operating speed,” “high speed,” and “normal speed,” as used herein, refer to the speed at which the fan normally operates during a cooling cycle in a conventional air conditioning system, including all variations of such speeds among various manufacturer's fans and system configurations. Similarly, the terms “low speed,” “reduced speed,” and “lowered speed,” as used herein, refer to the reduction in fan speed typically associated with a lower motor speed tap or any other means of reducing the blower speed, including all variations of such speeds among various manufacturer's fans and system configurations. The terms also include the fan speeds to which some conventional air conditioning systems are lowered during forced fan activation after compressor deactivation in a typical cooling cycle.

The term “AC-Enhancer,” refers to a device usable in exemplary embodiments of the present invention, which enables the execution of steps in the methods of the present invention.

### DETAILED DESCRIPTION

Related U.S. Provisional Application No. 60/941,508, filed Jun. 1, 2007, by the inventor herein, is incorporated herein by reference, in its entirety, for all purposes.

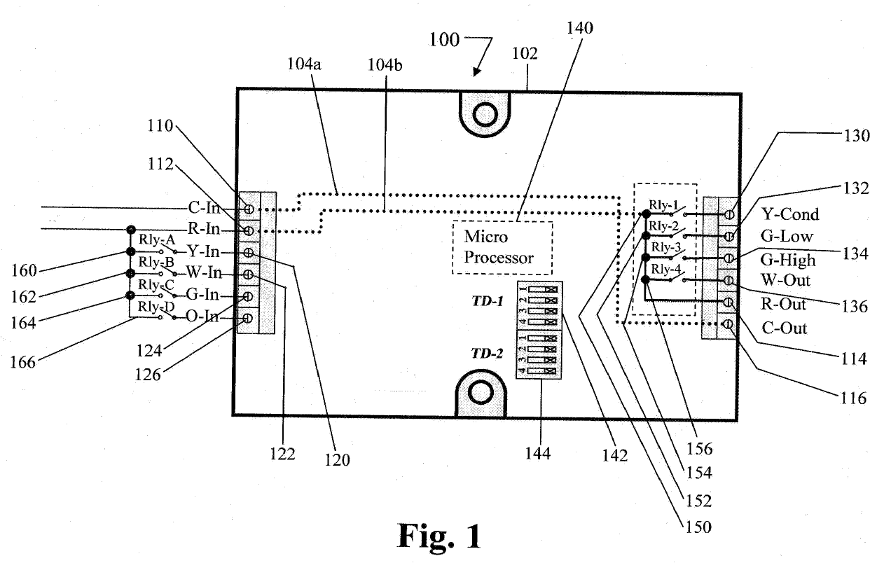

Turning now to FIG. 1, wherein an exemplary embodiment 100 of the present invention is illustrated. In this exemplary embodiment, and as illustrated in FIG. 1, a frame 102, encloses and/or positions conventional 24 volt AC power wiring 104a,b, thermostat-side terminals “C-In” 110, “R-In” 112, “Y-In” 120, “W-In” 122, “G-In” 124, and “O-In” 126, air handler-side terminals “R-Out” 114, “C-Out” 116, “Y-Cond” 130, “G-Low” 132, “G-High” 134, and “W-Out” 136, a microprocessor 140 programmed for establishing timed, energizing communication between selected thermostat-side terminals and selected air-handler side terminals, the microprocessor having time delays programmed to delay such energizing communications, dip switches “TD-1” 142 and “TD-2” 144 for setting the microprocessor time delay intervals, and air-handler side relays “Rly-1” 150, “Rly-2” 152, “Rly-3” 154, and “Rly-4” 156, the relays responding to the microprocessor by establishing and/or interrupting selected energizing communications. Thermostat signals to selected thermostat-side terminals are established and/or interrupted by external relays “Rly-A” 160, “Rly-B” 162, “Rly-C” 164, and “Rly-D” 166.

The R-In, R-Out, C-In, and C-Out terminals are operatively connected to enable the 24 volt AC power distribution. As will be explained in detail below, the G-In terminal is associated with the activation/deactivation of the fan, through the G-Low terminal for a low fan speed, and through both the G-Low and G-High terminals for a high fan speed. The Y-In terminal is associated with the activation/deactivation of the condenser, through the Y-Cond terminals. The W-In terminal is associated with the activation/deactivation of the separate inside heating coil used for the heating mode in traditional, non-heat pump, electric and/or natural gas systems, through the W-Out terminal.

Further, the O-In terminal is associated with a heat pump's reversing valve such that, when O-In is energized, the reversing valve is set for cooling, and when O-In is de-energized, the reversing valve is set for heating. In some exemplary embodiments of the present invention, the device 100 is adaptable to both heat pump systems and non-heat pump systems, in that the device 100 will recognize that cooling is being requested when the O-In terminal is energized. In non-heat pump systems, the O-In terminal is configured to be energized by the same thermostat signal that energizes the Y-In terminal, which will then energize the Y-Cond terminal, which in turn activates the condenser. In some exemplary embodiments, the device is specially configured for the non-heat pump system and does not include and/or does not require an O-In terminal.

In some exemplary embodiments of the type depicted in FIG. 1, the TD-1 dip switch assembly 142 subtracts five seconds from the related delay for each of the four switches that is moved to the “ON” position, and the TD-2 dip switch assembly 144 subtracts 30 seconds from the related delay for each of the four switches.

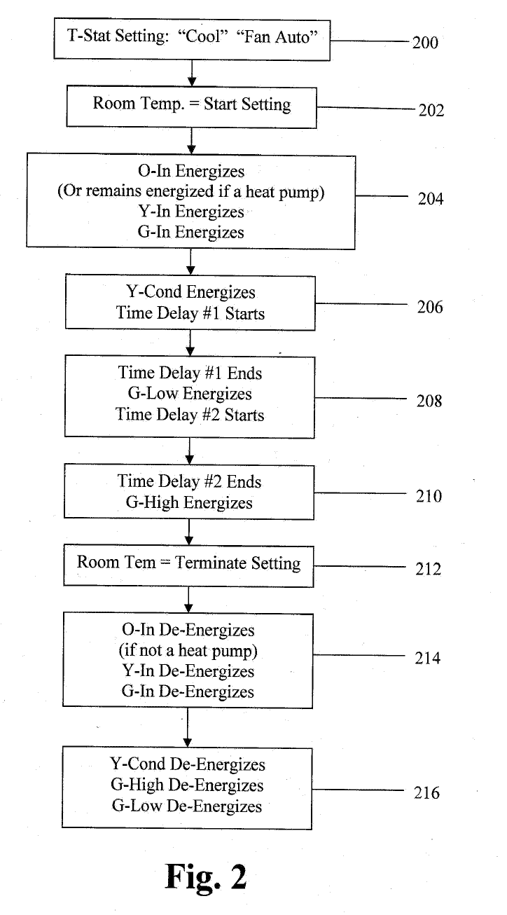

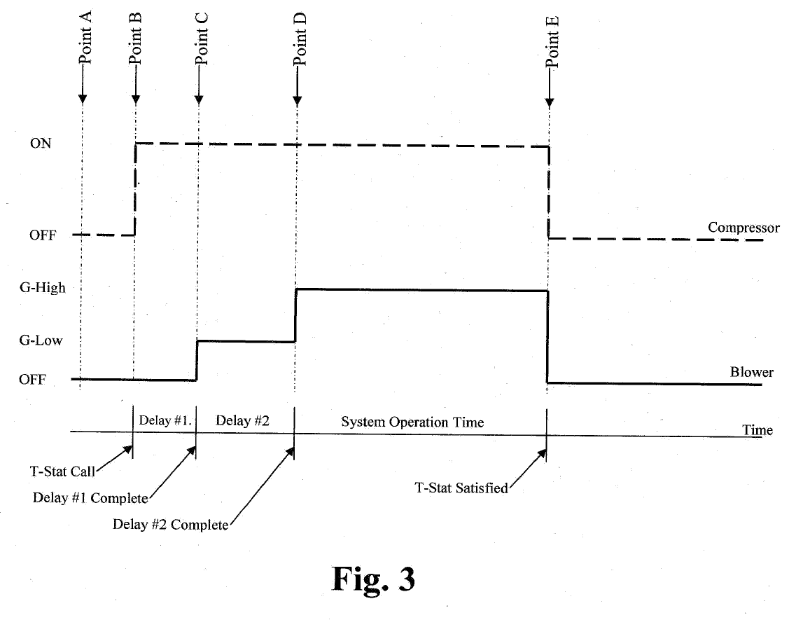

Turning now to FIGS. 2 and 3, wherein an exemplary embodiment of the present invention is depicted and shown to comprise the use of a device 100 and methods, to optimize the performance of an air conditioning system wherein conditioning is initiated and terminated in response to signals from a conditioner initiator, the system having a compressor, a condenser, an expansion device, and a cooling coil, operatively connected to function such that air is conditioned, and an air mover for passing air from a space across the cooling coil to cool and dehumidify the air, then back into the space. The use of the device 100 in the exemplary embodiment of the present invention described in FIGS. 2 and 3, is in association with the air conditioning system where the thermostat is initially 200 set to “COOL” and “FAN AUTO.” At this stage, the compressor, condenser and fan are not activated. When a room status 202 occurs wherein the room temperature reaches the starting temperature setting, a conditioning initiation signal, a cooling request, is sent by the conditioner initiator, a thermostat in this exemplary embodiment. In the response 204 of this exemplary embodiment of the present invention, G-In terminal energizes, Y-In terminal energizes, and O-In terminal energizes (jointly with the Y-In terminal for a non-heat pump system) or remains energized (for a heat pump system, as a result of the thermostat “COOL” setting). As a result, and as shown in the device response 206, Y-Cond terminal is energized which activates the compressor and the condenser (i.e. the outside coil and its blower), and the microprocessor causes a pre-set Time Delay #1 to start. At this stage, shown as Point B in FIG. 3, the compressor is activated, the fan is not-activated, Time Delay #1 has started, and the inside cooling coil begins to become colder.

Following the expiration of Time Delay #1, the device responds 208 by energizing G-Low terminal and starting a pre-set Time Delay #2. At this stage, shown as Point C in FIG. 3, the compressor remains activated, Time Delay #2 has started, and the fan begins operating at low speed, and will continue at low speed until the expiration of Time Delay #2.

Following the expiration of Time Delay #2, the device 100 responds 210 by energizing G-High terminal. At this stage, shown as Point D in FIG. 3, the fan is activated to run at normal operating speed.

When a room status 212 occurs, such that the room temperature causes the conditioner initiator to send a conditioning termination signal, the device responds 214 by de-energizing G-In terminal, Y-In terminal, and O-In terminal (for non-heat pump systems only), which in turn causes a response 216 de-energizing Y-Cond terminal, de-energizing G-High terminal, and de-energizing G-Low terminal. At this stage, shown as Point E in FIG. 3, the compressor is deactivated, along with the condenser, and the fan is deactivated. This status remains until a subsequent cooling cycle is requested.

In exemplary embodiments of the type illustrated in FIGS. 1-3, Time Delay #1 may be set between approximately 15-45 seconds, although the optimal time is approximately 25-30 seconds. In some exemplary embodiments, dip switches 142 are provided for the user to adjust the length of Time Delay #1, and in some exemplary embodiments the number of dip switches is four and the incremental change in time is 5 seconds. Similarly, Time Delay #2 may be set between approximately 20-240 seconds, although the optimal time is approximately 60-120 seconds. In some exemplary embodiments, dip switches 142 are provided for the user to adjust the length of Time Delay #2, and in some exemplary embodiments the number of dip switches is four and the incremental change in time is 30 seconds.

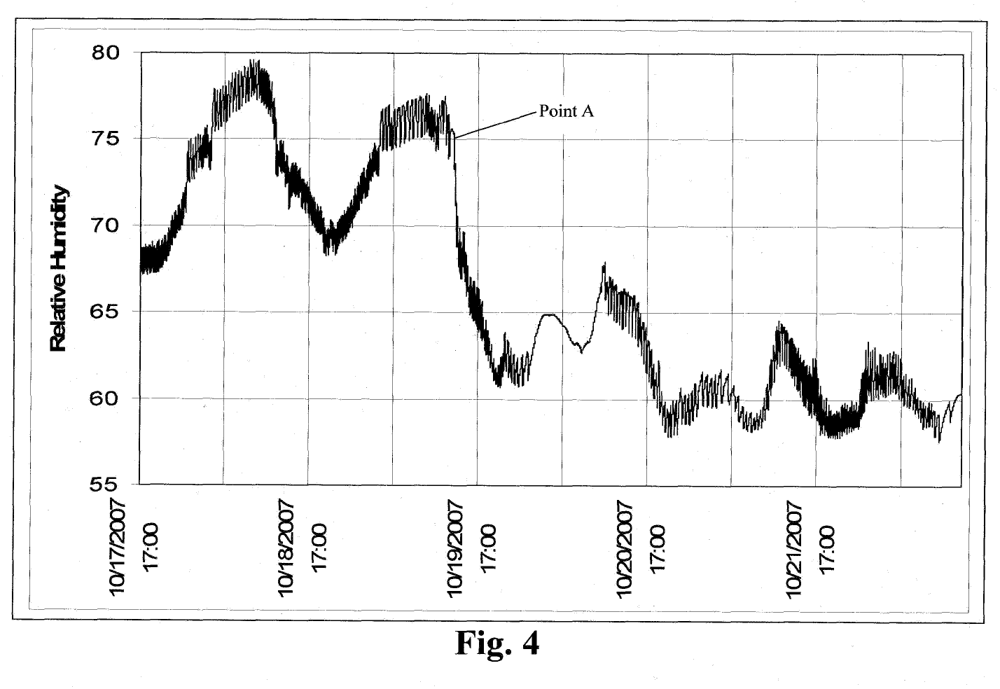

An exemplary embodiment of the present invention was tested at a residence in association with the existing air conditioning system in the home. The air conditioning system was not a heat pump system. The system was set up such that the fan was simultaneously activated with the compressor and condenser. In such an installation of the present invention, a jumper wire was connected between Y-In terminal and O-In terminal. (As discussed elsewhere in this disclosure, this simultaneously energizes Y-In terminal and O-In terminal, the energized O-In terminal being required by the tested embodiment to initiate a cooling cycle instead of a heating cycle.) The residential system did not have the fan activation after compressor deactivation feature. FIG. 4 shows the results of the test in terms of measured relative humidity before and after installation of the present invention. For approximately two days temperature and relative humidity measurements were taken in a room (the “upstairs sitting room”). After such period an embodiment of the present invention was installed (Point A) and the same data collected for approximately two days. The average relative humidity in the room was improved from an average of approximately 73 percent to approximately 60 percent, with no negative temperature effect caused by the operation of the device.

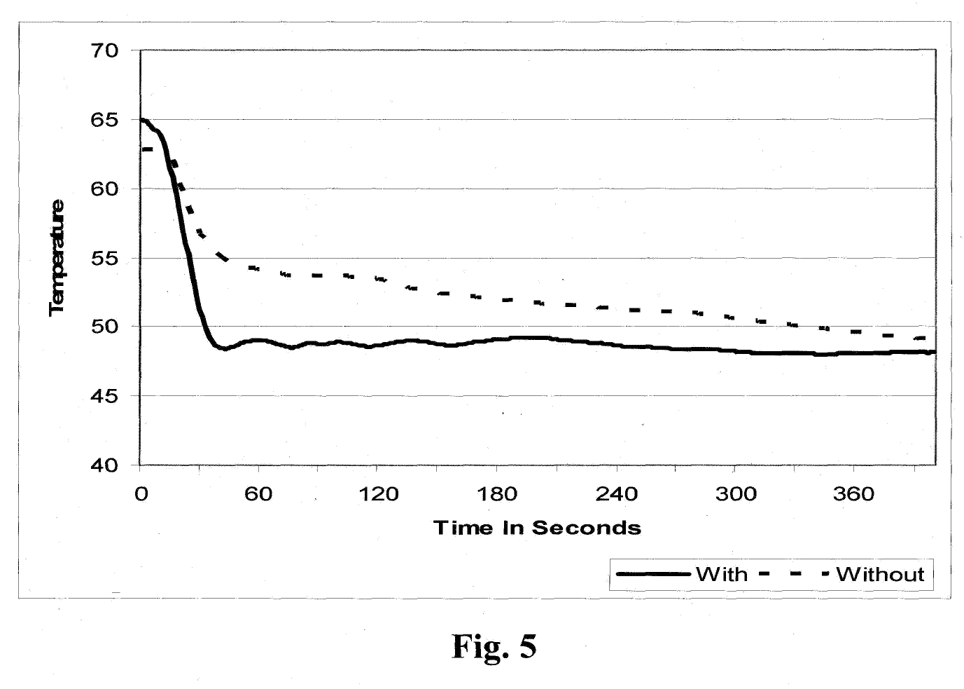

Another test of an exemplary embodiment of the present invention was conducted at another residence in association with the existing air conditioning system in the home. The air conditioning system was not a heat pump system. The system was set up such that the fan was simultaneously activated with the compressor and condenser. In such an installation of the present invention, a jumper wire was connected between Y-In terminal and O-In terminal. The residential system did not have the fan activation after compressor deactivation feature. Temperature measurements were taken at the inside cooling coil for about six minutes, once without the present invention installed, and once with it installed. As shown on FIG. 5, the inside cooling coil is cooled much more quickly when the tested embodiment of the present invention is installed. Without the device installed, it took at least 6 minutes for the inside cooling coil to decrease to the temperature achieved by the system with the device in about 45 seconds. The graph line for the system with the device installed is also shown in FIG. 5 to have very little fluctuation until the cooling cycle terminated later. This shows how the device reaches peak efficiency and dehumidification capacity much faster than the same system without the enhancement provided by the present invention.

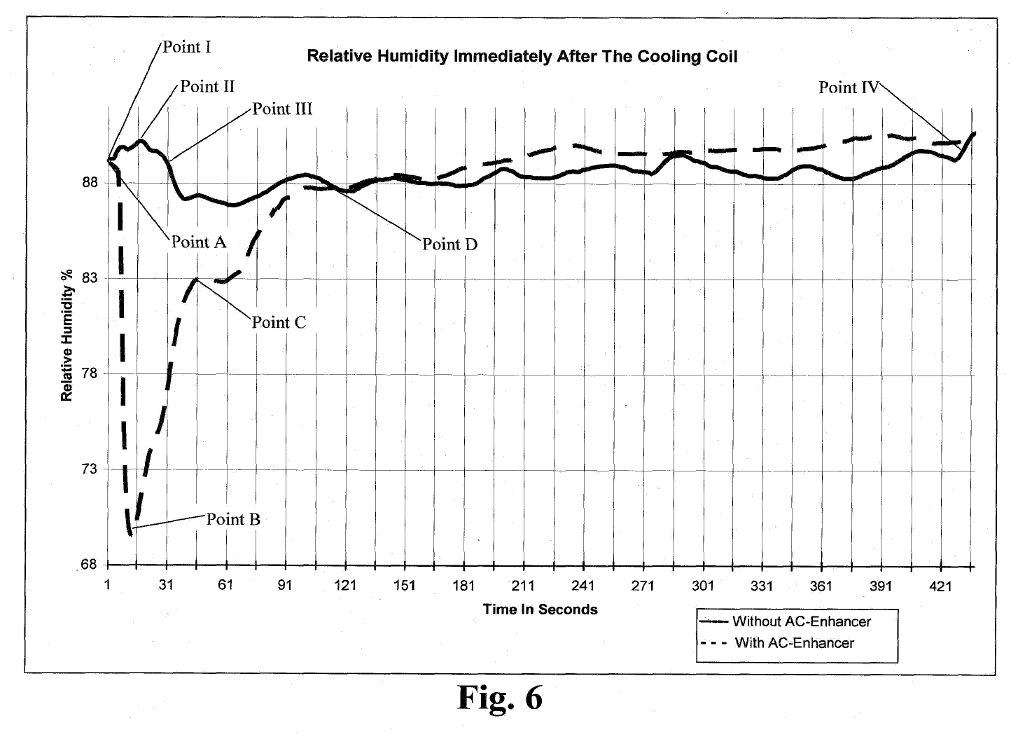

Another test was run at the same residence as the test described in association with FIG. 5, with the results presented in FIG. 6. Relative humidity immediately after the inside cooling coil was measured over several minutes, both before and after the installation of the test embodiment of the device. Without the device the compressor, condenser and fan start together at Point I, causing immediate re-evaporization of moisture on the cooling coil, because the cooling coil is warm and substantially unable to retain the moisture on the coil. This re-evaporization caused an immediate increase in relative humidity that extends for over 30 seconds, with an example data point being shown as Point II, the re-evaporatization begins to reduce as the cooling coil starts to cool down at Point III. Peak dehumidification stabilizes only after approximately 7 minutes as shown at Point IV. The result being the loss of a substantially amount of the moisture from the cooling coil which, in turn, causes an extended period before peak dehumidification capacity is reached. With the test embodiment of the present invention, however, the compressor and condenser only start at Point A at which time the cooling coil begins to cool while maintaining the existing moisture on the coil, and causing a relative humidity drop immediately after the cooling coil as the cooling coil immediately starts pulling moisture out of the air. When the fan is activated at reduced speed (Point B) the cooling coil quickly begins to move toward its peak dehumidification capacity, where the relative humidity measurement will be high due to the rapidly increasing moisture on the cooling coil. The reduced speed optimizes the system's ability to retain originally present, and newly condensed, moisture as the system moves toward peak dehumidification capacity. At the end of the period of reduced fan speed the system has moved as far toward peak dehumidification capacity as is practical without additional fan speed, so the fan is activated to normal operating speed (Point C). At this point the system again moves toward peak dehumidification capacity, which is reached (Point D) in less than approximately 2 minutes from the time the compressor was activated—much quicker than the system without the test embodiment.

In the exemplary embodiments of the present invention described above with reference to FIGS. 2 and 3, an initial thermostat setting of “FAN AUTO” was assumed, and is applicable only to air conditioning systems that do not include the 30-45 second forced fan activation following deactivation of the compressor at the end of a cooling cycle, the problem associated with such a feature being discussed earlier. Such problem is also associated with a thermostat setting of “FAN ON.” Exemplary embodiments of the present invention are provided to address this problem when the device is used on an air conditioning system that includes the 30-45 second forced fan activation at termination feature and/or any system allowing continuous fan mode, i.e. when the “FAN ON” setting is chosen by the user on the thermostat.

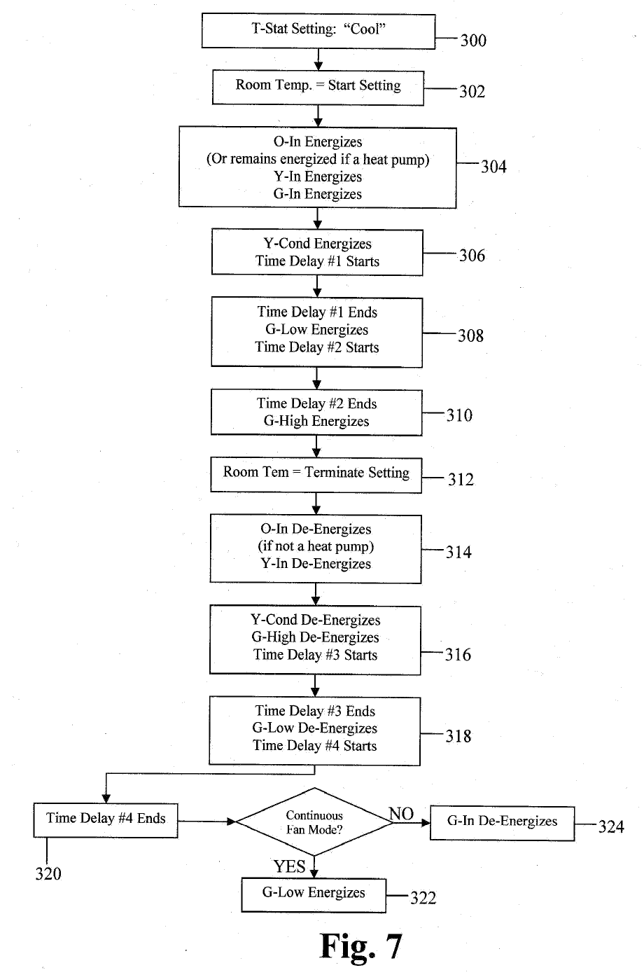

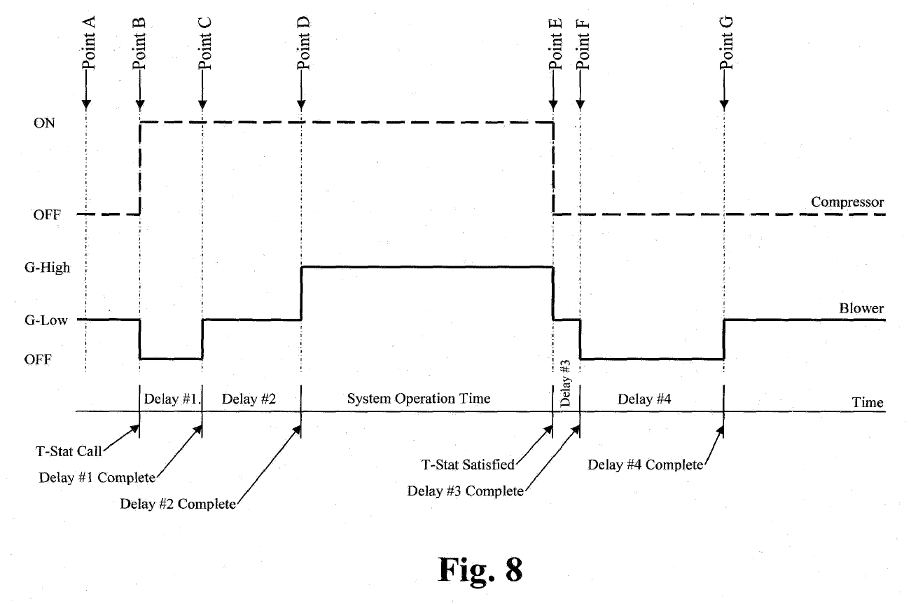

Turning now to FIGS. 7 and 8, wherein an exemplary embodiment of the present invention is depicted and shown to comprise the use of a device and method, to optimize the performance of an air conditioning system wherein conditioning is initiated and terminated in response to signals from a conditioner initiator, the system having a compressor, a condenser, an expansion device, and a cooling coil, operatively connected to function such that air is conditioned, and an air mover for passing air from a space across the cooling coil to cool and dehumidify the air, then back into the space. The use of the device in the exemplary embodiment of the present invention described in FIGS. 7 and 8, is in association with the air conditioning system where the thermostat is initially 300 set to “COOL” and “FAN AUTO.” At this stage, the compressor, condenser and fan are not activated, as shown by Point A in FIG. 8. When a room status 302 occurs wherein the room temperature reaches the starting temperature setting, a conditioning initiation signal, a cooling request, is sent by the conditioner initiator, a thermostat in this exemplary embodiment. In the response 304 of this exemplary embodiment of the present invention, G-In terminal energizes, Y-In terminal energizes, and O-In terminal energizes (jointly with the Y-In terminal for a non-heat pump system) or remains energized (for a heat pump system, as a result of the thermostat “COOL” setting). As a result, and as shown in the device response 306, Y-Cond terminal is energized which activates the compressor and the condenser, and the microprocessor causes a pre-set Time Delay #1 to start. At this stage, shown as Point B in FIG. 8, the compressor is activated, the fan is not-activated, Time Delay #1 has started, and the inside cooling coil begins to become colder.

Following the expiration of Time Delay #1, the device responds 308 by energizing G-Low terminal and starting a pre-set Time Delay #2. At this stage, shown as Point C in FIG. 8, the compressor remains activated, Time Delay #2 has started, and the fan begins operating at low speed, and will continue at low speed until the expiration of Time Delay #2.

Following the expiration of Time Delay #2, the device responds 310 by energizing G-High terminal. At this stage, shown as Point D in FIG. 8, the fan is activated to run at normal operating speed.

When a room status 312 occurs, such that the room temperature causes the conditioner initiator to send a conditioning termination signal, the device responds 314 by de-energizing G-In terminal, Y-In terminal, and O-In terminal (for non-heat pump systems only), which in turn causes a response 316 de-energizing Y-Cond terminal, de-energizing G-High terminal, and starting Time Delay #3. At this stage, shown as Point E in FIG. 8, the compressor is de-activated, the fan speed is lowered, and Time Delay #3 is started.

Following the expiration of Time Delay #3, the device responds 318 by de-energizing G-Low terminal and starting Time Delay #4. At this stage, shown as Point F in FIG. 8, the fan is de-activated and Time Delay #4 has started.

Following the expiration 320 of Time Delay #4, if the air conditioning system thermostat has been set to “FAN ON,” then G-Low terminal is energized 322. At this stage, as shown by Point G in FIG. 8, the fan is activated at the low speed until a subsequent cooling cycle starts. If, following the expiration 320 of Time Delay #4, the thermostat has been set to “FAN AUTO,” then G-Low terminal remains de-energized 324 until a subsequent cooling cycle.

The foregoing exemplary embodiment has been described to include Time Delay #3, which is optimally set at approximately four seconds, although, a range of 1 to 5 seconds performs acceptably. As discussed above, conventional air conditioning systems force the fan to remain activated for approximately 30-45 seconds following compressor deactivation, causing moisture to be re-evaporated from the cooling coil back into the air entering the air conditioned space. In conventional systems the command to remain activated may originate from the thermostat or from separate circuitry in the air handler. The command will be defeated upon recognition that the fan remains activated, which will typically occur in conventional systems when the thermostat is set to “FAN ON,” for continuous fan mode. Accordingly, in the exemplary embodiments of the present invention described with respect to FIGS. 7 and 8, the Time Delay #3 causes the fan to remain running during the delay, as if in continuous fan mode, and the command is defeated because the system detects that the fan is running. This detection occurs very quickly after the compressor is deactivated, so Time Delay #3 can be very short, thus avoiding the problem of blowing moisture from the cooling coil back into the air condition space.

Time Delay #4, on the other hand, is set for an extended time period to force the fan to remain deactivated long enough to maximize the natural drainage of moisture from the cooling coil—even when the thermostat is set to “FAN ON.” Time Delay #4 is effective to varying degrees when set between 3-30 minutes, although approximately 10 minutes is optimum. In some exemplary embodiments of the present invention, if the room temperature reaches the starting temperature setting during Time Delay #4, Time Delay #4 is terminated and the device begins performing in accordance with the above-described applications.

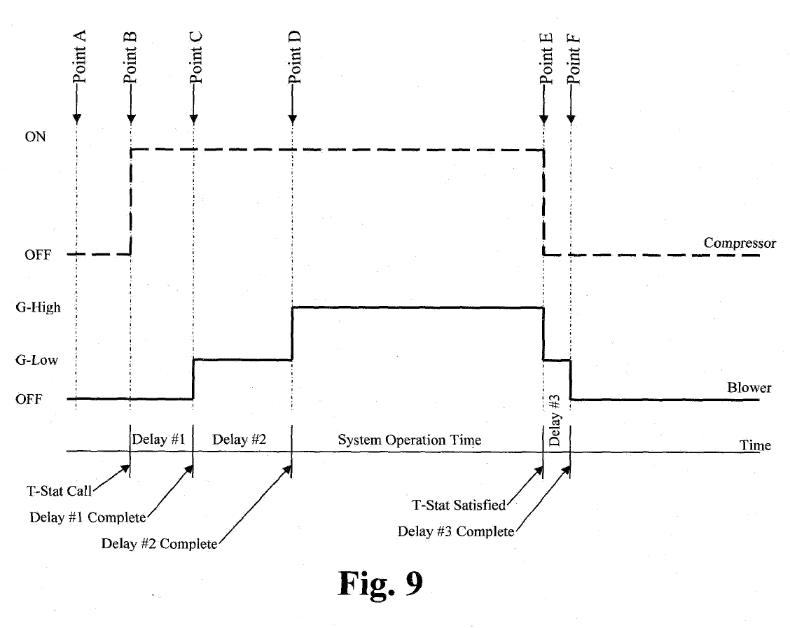

To avoid a multiplication of commercial products, the Time Delay #3 feature is present on some exemplary embodiments of the device intended for use with conventional air conditioning systems that do not have the forced fan activation for 30-45 seconds after compressor deactivation feature. Turning now to FIG. 9, wherein the performance of the device having the Time Delay #3 feature on such an air conditioning system is illustrated and is shown at Point E to begin the Time Delay #3 immediately following the deactivation of the compressor, even though the short, non-problematic, continued duration of fan activation is not necessary.

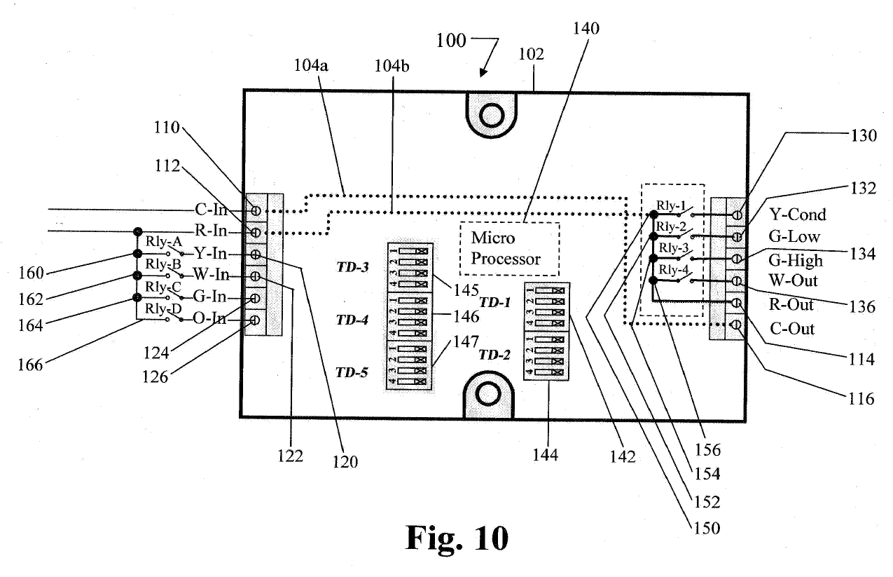

In exemplary embodiments of the type illustrated in FIGS. 7-9, Time Delay #3 may be set between approximately 1-5 seconds, although the optimal time is approximately 4 seconds. In some exemplary embodiments, the length of Time Delay #3 is fixed, however, as illustrated in FIG. 10, a time delay TD-3 145 having dip switches is provided for the user to adjust the length of Time Delay #3, and in some exemplary embodiments the number of dip switches is four and the incremental change in time is 1 second. Similarly, Time Delay #4 may be set between approximately 3-30 minutes, although the optimal time is approximately 10 minutes. In some exemplary embodiments, the length of Time Delay #4 is fixed, however, as illustrated in FIG. 10, a time delay TD-4 146 having dip switches is provided for the user to adjust the length of Time Delay #4, and in some exemplary embodiments the number of dip switches is four and the incremental change in time is 9 minutes.

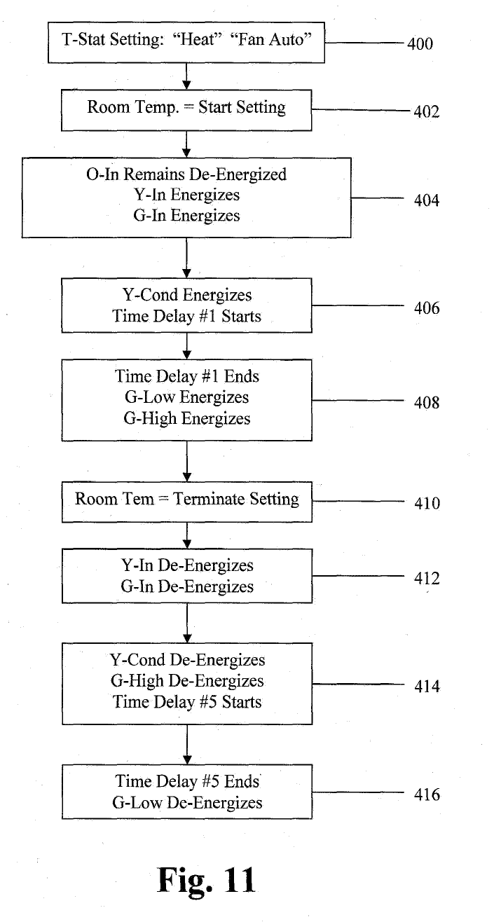

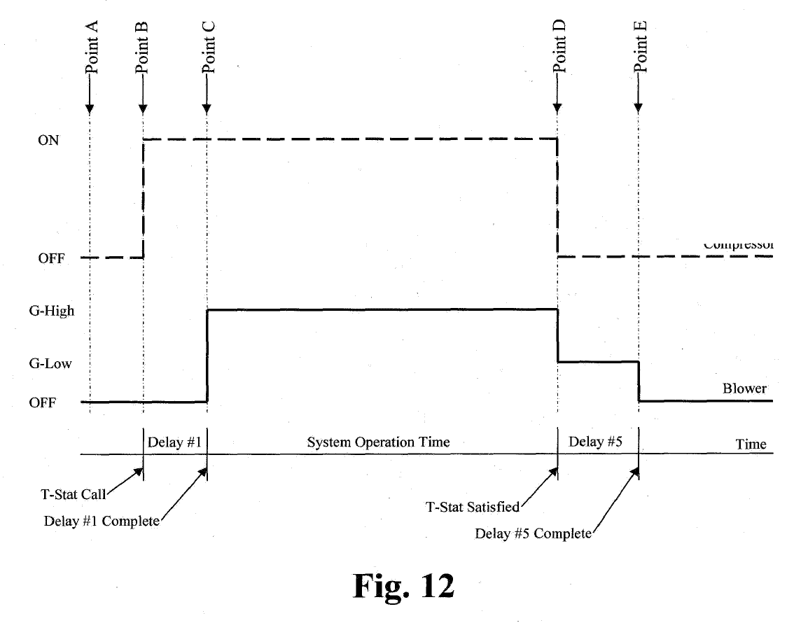

Turning now to FIGS. 11 and 12, wherein exemplary embodiments of the present invention are depicted and shown to comprise the use of a device and methods, to optimize the performance of a heat pump air conditioning system wherein conditioning is initiated and terminated in response to signals from a conditioner initiator, the system having a compressor, a condenser, an expansion device, a reversing valve, and an inside cooling coil, operatively connected to function such that air is conditioned by heating, and an air mover for passing air from a space across the inside cooling coil for heating the air, then back into the space. The use of the device in the exemplary embodiment of the present invention described in FIGS. 11 and 12, is in association with the heat pump air conditioning system where the thermostat is initially 400 set to “HEAT” and “FAN AUTO.” At this stage, the compressor, condenser and fan are not activated, as shown by Point A in FIG. 12. When a room status 402 occurs wherein the room temperature reaches the starting temperature setting, a conditioning initiation signal, a heating request, is sent by the conditioner initiator, a thermostat in this exemplary embodiment. In the response 404 of this exemplary embodiment of the present invention, G-In terminal energizes, Y-In terminal energizes, and O-In terminal remains de-energized (for a heat pump system, as a result of the thermostat “HEAT” setting). As a result, and as shown in the device response 406, Y-Cond terminal is energized which activates the compressor and the condenser, and the microprocessor causes a pre-set Time Delay #1 to start. At this stage, shown as Point B in FIG. 12, the compressor is activated, the fan is not-activated, Time Delay #1 has started, and the inside cooling coil begins to become hotter.

Following the expiration of Time Delay #1, the device responds 408 by energizing G-Low terminal and energizing G-High terminal. At this stage, shown as Point C in FIG. 12, the fan is activated to run at normal operating speed.

When a room status 410 occurs, such that the room temperature causes the conditioner initiator to send a conditioning termination signal, the device responds 412 by de-energizing Y-In terminal, which in turn causes a response 414 de-energizing Y-Cond terminal, de-energizing G-High terminal, and starting Time Delay #5. At this stage, shown as Point D in FIG. 12, the compressor is deactivated, the fan speed is lowered, and Time Delay #5 is started.

Following the expiration of Time Delay #5, the device responds 416 by de-energizing G-Low terminal. At this stage, as shown by Point E in FIG. 12, the fan is deactivated until a subsequent heating cycle starts.

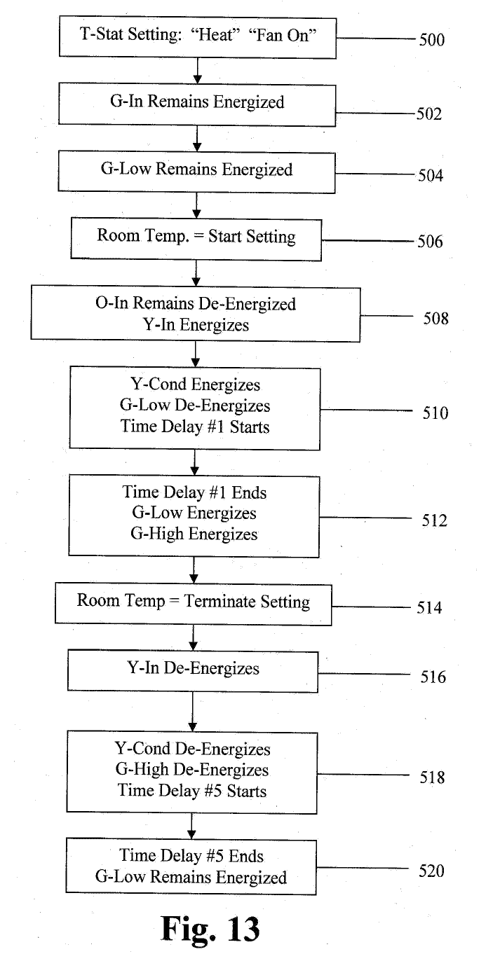

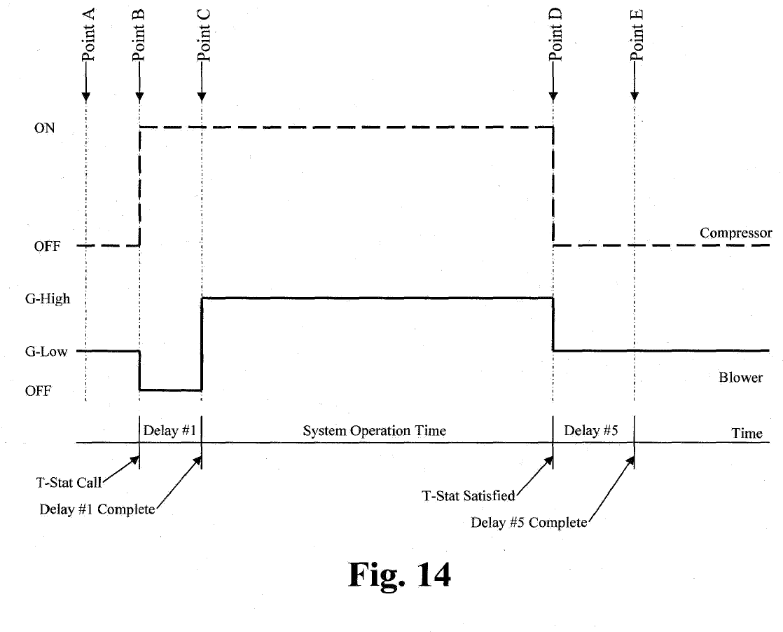

Turning now to FIGS. 13 and 14, wherein exemplary embodiments of the present invention are depicted and shown to comprise the use of a device and methods, to optimize the performance of a heat pump air conditioning system wherein conditioning is initiated and terminated in response to signals from a conditioner initiator, the system having a compressor, a condenser, an expansion device, a reversing valve, and an inside cooling coil, operatively connected to function such that air is conditioned by heating, and an air mover for passing air from a space across the inside cooling coil for heating the air, then back into the space. The use of the device in the exemplary embodiment of the present invention described in FIGS. 13 and 14, is in association with the heat pump air conditioning system where the thermostat is initially 500 set to “HEAT” and “FAN ON.” At this stage, the compressor and condenser are not activated, but the fan is operating at low speed, as shown by Point A in FIG. 14. In this condition, the device leaves 502 G-In terminal energized and leaves 504 G-Low terminal energized. When a room status 506 occurs wherein the room temperature reaches the starting temperature setting, a conditioning initiation signal, a heating request, is sent by the conditioner initiator, a thermostat in this exemplary embodiment. In the response 508 of this exemplary embodiment of the present invention, Y-In terminal energizes and O-In terminal remains de-energized (for a heat pump system, as a result of the thermostat “HEAT” setting). As a result, and as shown in the device response 510, Y-Cond terminal is energized, which activates the compressor and the condenser, G-Low de-energizes, which turns the fan off, and the microprocessor causes a pre-set Time Delay #1 to start. At this stage, shown as Point B in FIG. 14, the compressor is activated, the fan is not-activated, Time Delay #1 has started, and the inside cooling coil begins to become hotter.

Following the expiration of Time Delay #1, the device responds 512 by energizing G-Low terminal and energizing G-High terminal. At this stage, shown as Point C in FIG. 14, the fan is activated to run at normal operating speed.

When a room status 514 occurs, such that the room temperature causes the conditioner initiator to send a conditioning termination signal, the device responds 516 by de-energizing Y-In terminal, which in turn causes a response 518 de-energizing Y-Cond terminal, de-energizing G-High terminal, and starting Time Delay #5. At this stage, shown as Point D in FIG. 14, the compressor is deactivated, the fan speed is lowered, and Time Delay #5 is started.

Following the expiration of Time Delay #5, the device allows 520 the G-Low terminal to remain energized. At this stage, as shown by Point E in FIG. 14, the fan remains activated at the lower speed until a subsequent heating cycle starts.

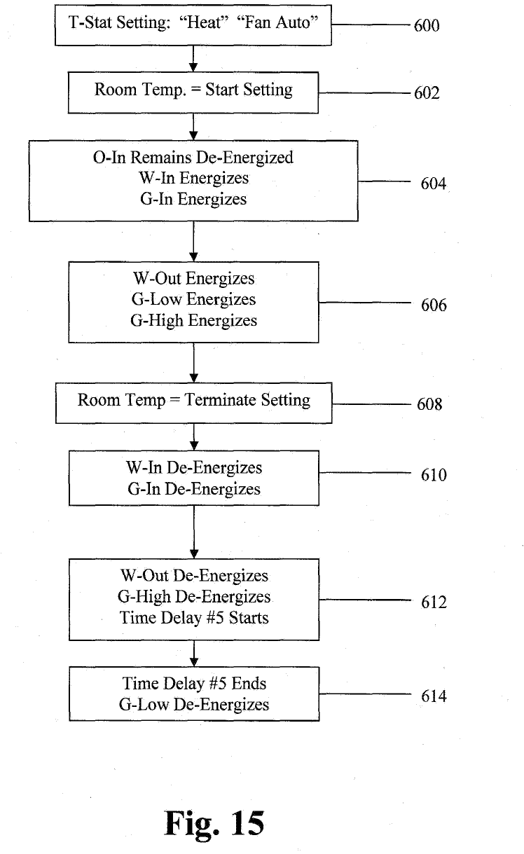

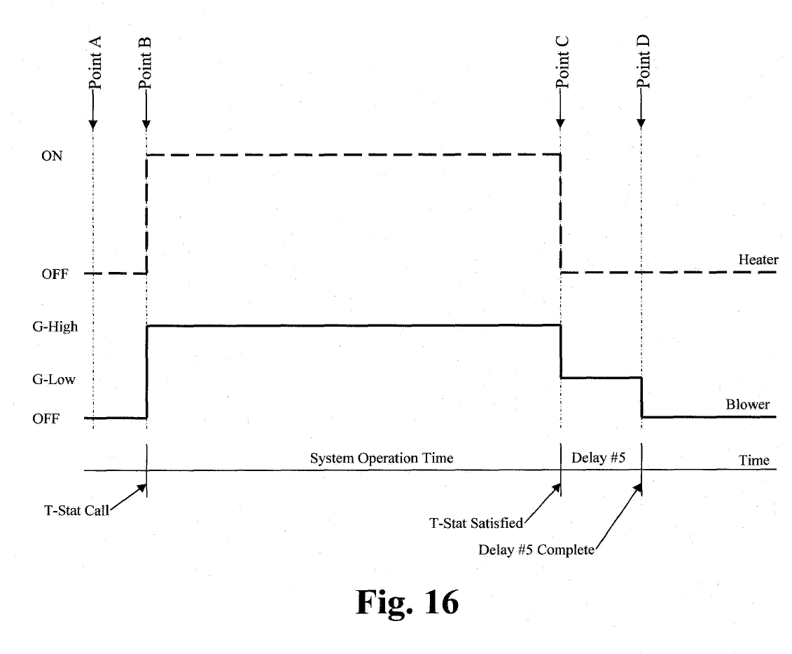

Turning now to FIGS. 15 and 16, wherein exemplary embodiments of the present invention are depicted and shown to comprise the use of a device and methods, to optimize the performance of an air conditioning system wherein conditioning is initiated and terminated in response to signals from a conditioner initiator, the system having a compressor, a condenser, an expansion device, a reversing valve, an inside cooling coil, and a heating coil, heated by natural gas and/or electricity, the heating coil being operatively connected to function such that air is conditioned by heating, and an air mover for passing air from a space across the heating coil for heating the air, then back into the space. The use of the device in the exemplary embodiment of the present invention described in FIGS. 15 and 16, is in association with the air conditioning system where the thermostat is initially 600 set to “HEAT” and “FAN AUTO.” At this stage, the compressor, condenser, heating coil and fan are not activated, as shown by Point A in FIG. 16. When a room status 602 occurs wherein the room temperature reaches the starting temperature setting, a conditioning initiation signal, a heating request, is sent by the conditioner initiator, a thermostat in this exemplary embodiment. In the response 604 of this exemplary embodiment of the present invention, G-In terminal energizes, W-In terminal energizes, and O-In terminal remains de-energized. As a result, and as shown in the device response 606, W-Out terminal energizes, which activates the heating coil, G-Low energizes and G-High energizes. At this stage, the heating coil is being heated and the fan is activated at normal operating speed, as shown by Point B in FIG. 16.

When a room status 608 occurs, such that the room temperature causes the conditioner initiator to send a conditioning termination signal, the device responds 610 by de-energizing G-In terminal and W-In terminal, which in turn causes a response 612 de-energizing W-Out terminal and de-energizing G-High terminal, and starting Time Delay #5. At this stage, shown as Point C in FIG. 16, the heating coil is deactivated, the fan speed is lowered, and Time Delay #5 is started.

Following the expiration of Time Delay #5, the device responds 614 by de-energizing G-Low terminal. At this stage, as shown by Point D in FIG. 16, the fan is deactivated until a subsequent heating cycle starts.

Time Delay #5 may be set between approximately 15-95 seconds, although the optimal time is approximately 45 seconds. In some exemplary embodiments, the length of Time Delay #5 is fixed, however, as illustrated in FIG. 10, a time delay TD-5 147 having dip switches is provided for the user to adjust the length of Time Delay #5, and in some exemplary embodiments the number of dip switches is four and the incremental change in time is 20 seconds.

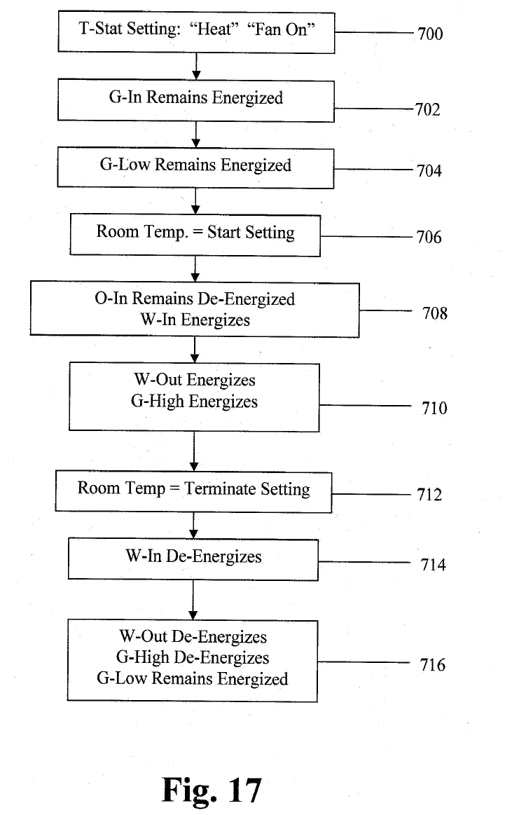

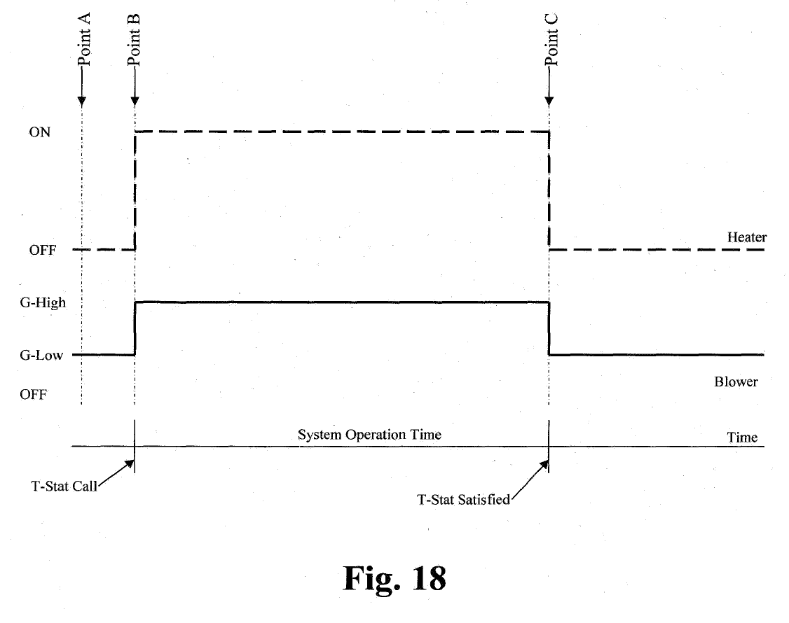

Turning now to FIGS. 17 and 18, wherein exemplary embodiments of the present invention are depicted and shown to comprise the use of a device and methods, to optimize the performance of an air conditioning system wherein conditioning is initiated and terminated in response to signals from a conditioner initiator, the system having a compressor, a condenser, an expansion device, a reversing valve, an inside cooling coil, and a heating coil, heated by natural gas and/or electricity, the heating coil being operatively connected to function such that air is conditioned by heating, and an air mover for passing air from a space across the heating coil for heating the air, then back into the space. The use of the device in the exemplary embodiment of the present invention described in FIGS. 17 and 18, is in association with the air conditioning system where the thermostat is initially 700 set to “HEAT” and “FAN ON.” At this stage, the compressor, condenser, and heating coil are not activated, and the fan is activated at a reduced speed, as shown by Point A in FIG. 18, in that G-In remains 702 energized and G-Low remains 704 energized in accordance with the continuous fan mode setting. When a room status 706 occurs wherein the room temperature reaches the starting temperature setting, a conditioning initiation signal, a heating request, is sent by the conditioner initiator, a thermostat in this exemplary embodiment. In the response 708 of this exemplary embodiment of the present invention, W-In terminal energizes, and O-In terminal remains de-energized. As a result, and as shown in the device response 710, W-Out terminal energizes which activates the heating coil, and G-High energizes. At this stage, the heating coil is being heated and the fan is activated at normal operating speed, as shown by Point B in FIG. 18.

When a room status 712 occurs, such that the room temperature causes the conditioner initiator to send a conditioning termination signal, the device responds 714 by de-energizing W-In terminal, which in turn causes a response 716 de-energizing W-Out terminal and de-energizing G-High terminal. At this stage, shown as Point C in FIG. 18, the heating coil is deactivated and the fan speed is lowered as desired in the continuous fan mode setting, It should be noted that the benefits of continuing to move air across the heating coil for approximately 45 seconds (as was done in the exemplary embodiment illustrated in FIGS. 15 and 16, are achieved by the continued activation of the fan at the reduced speed.

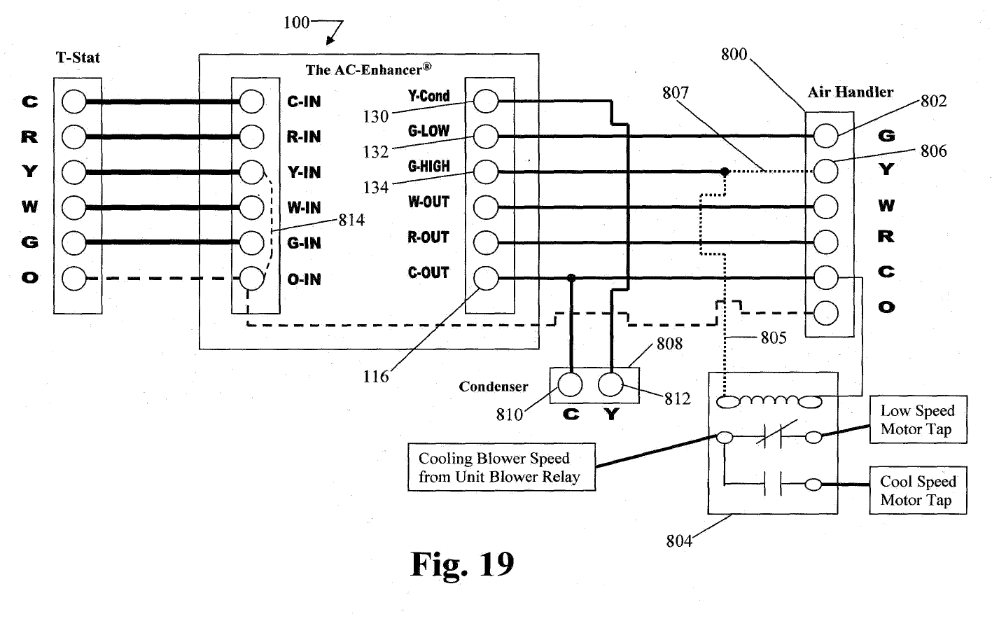

Turning now to FIG. 19, wherein a wiring diagram for an exemplary embodiment 100 of the present invention is illustrated and depicts symbolic wiring between the G-Low terminal 132 and a corresponding “G” terminal 802 in the air handler 800 electronics such that the fan runs at reduced speed when G-Low terminal is energized. Also, shown is the wiring 805 from the G-High terminal 134 to a relay 804 (such as a conventional 90370 relay) which is provided for some, usually older, installations where the existing air handler circuit board doesn't automatically recognize requests for fan speed changes. In installations without the device of the present invention, the G-High terminal wiring 807 is typically extended directly to the air handler “Y” terminal 806 because it will combine the activation of the condenser and the full fan speed in its normal operation. In this exemplary embodiment, the condenser 808 is only connected to the device by a “C” terminal 810 connected to a line from the C-Out terminal 116, and a “Y” terminal 812 connected to the Y-Cond terminal 130. As stated earlier the jumper wire 814 is run from the Y-In terminal 120 to the O-In terminal, in this non-heat pump system installation example. This simultaneously energizes Y-In terminal and O-In terminal, the energized O-In terminal being required in this example installation to initiate a cooling cycle instead of a heating cycle.

The methods and circuitry available in exemplary embodiments of the present invention also include embodiments wherein the response to a cooling request from the conditioner initiator results in the immediate activation of the air mover at normal operating speed, although such embodiments are less preferred.

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense.

1. A method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising:
alternately activating and deactivating the compressor and alternately activating and deactivating the air mover, the air mover activation comprising a first stage of zero speed, a second stage of reduced speed, and a third stage of substantially full speed;
responding to a conditioning initiation signal from the conditioner initiator such that the compressor is activated, the condenser is activated and the air mover begins the air mover first stage;
initiating the air mover second stage following the air mover first stage; and
initiating the air mover third stage following the air mover second stage.

2. The method of claim 1, further comprising: responding to a conditioning termination signal from the conditioner initiator by simultaneously deactivating the compressor and the air mover.

3. The method of claim 1, further comprising responding to a conditioning termination signal from the conditioner initiator by deactivating the compressor, reducing the air mover speed for approximately 1-5 seconds beginning at the compressor deactivation, and then deactivating the air mover.

4. The method of claim 1, wherein the air mover is normally continuously activated, the method further comprising: responding to a conditioning termination signal from the conditioner initiator by deactivating the compressor and deactivating the air mover, the air mover deactivation being for an extended time period.

5. The method of claim 1, wherein responding to a conditioning termination signal from the conditioner initiator further comprises deactivating the compressor, reducing the air mover speed for approximately 1-5 seconds beginning at the compressor deactivation, and then deactivating the air mover, the air mover deactivation being for the extended time period.

6. The method of claim 5, wherein the extended time period is approximately 10 minutes.

7. The method of claim 5, wherein the air mover deactivation extended time period is approximately 3 to 30 minutes.

8. The method of claim 5, wherein at the time the conditioner initiator signals for conditioning termination, moisture is present on the cooling coil, a portion of such moisture being drainable from the cooling coil, the drainable moisture portion being drained during the extended period of time during substantially all of which the air mover is deactivated.

9. The method of claim 1, wherein the air mover first stage is predetermined at between approximately 15-45 seconds.

10. The method of claim 1, wherein the air mover second stage is predetermined at between approximately 20-240 seconds.

11. The method of claim 1, wherein the air mover is normally continuously activated, and responding to a conditioning initiation signal from the conditioner initiator such that the air mover is activated to the air mover first stage, further comprises overriding the continuous activation of the air mover.

12. The method of claim 1, further comprising responding to a conditioning termination signal from the conditioner initiator by deactivating the compressor and causing the air mover to be deactivated for an extended time period, the method further comprising terminating the extended period of air mover deactivation as necessary to enable the air mover second stage following the air mover first stage in response to a conditioning initiation signal from the conditioner initiator.

13. The method of claim 1, wherein at the time the conditioner initiator signals for conditioning initiation, moisture is present on the cooling coil, and during the air mover first and second stages, the air returning to the space is substantially free of such moisture.

14. The method of claim 1, wherein a heating coil is operatively connected with the air mover for passing air from a space across the heating coil to heat the air, then back into the space, further comprising:
responding to a heat initiation signal from the conditioner initiator by activating the heating coil and air mover substantially simultaneously; and
responding to a heat termination signal from the conditioner initiator by deactivating the heating coil and deactivating the air mover after a time delay of approximately 15-95 seconds.

15. The method of claim 1, wherein a reversing valve is operatively connected with the compressor, condenser, expansion device, cooling coil and the air mover, to function such that air is conditioned in a heat mode, the cooling coil being heated in such mode, the method further comprising:
alternately activating and deactivating the compressor and alternately activating and deactivating the air mover, the air mover comprising a heat mode first stage of zero speed, and a heat mode second stage of substantially full speed;
responding to a heat conditioning initiation signal from the conditioner initiator such that the compressor is activated, the condenser is activated and the air mover begins the air mover heat mode first stage; and
initiating the air mover second stage following the air mover first stage.

16. The method of claim 15, wherein the air mover heat mode first stage is approximately 15-40 seconds.

17. The method of claim 15, further comprising: responding to a heat conditioning termination signal by deactivating the compressor and deactivating the air mover after a time delay of approximately 15-95 seconds.

18. A method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising:
responding to a conditioning initiation signal from the conditioner initiator such that the compressor, condenser and air mover are functioning to cool the air; and
responding to a conditioning termination signal from the conditioner initiator by deactivating the compressor, reducing the air mover speed for approximately 1-5 seconds beginning at the compressor deactivation, and then deactivating the air mover.

19. The method of claim 18, wherein the air mover is normally continuously activated, and further wherein the air mover deactivation following the reduced air mover speed is for an extended time period.

20. A method of conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the method comprising:
responding to a conditioning initiation signal from the conditioner initiator such that the compressor, condenser and air mover are functioning to cool the air; and
responding to a conditioning termination signal from the conditioner initiator by deactivating the compressor and deactivating the air mover, the air mover deactivation being for an extended time period.

21. The method of claim 21, wherein the air mover is normally continuously activated, and responding to a conditioning termination signal from the conditioner initiator further comprises reducing the air mover speed for approximately 1-5 seconds beginning at the compressor deactivation, prior to deactivating the air mover.

22. A method of conditioning the air in a space, wherein a compressor, a condenser, an expansion device, a reversing valve, and a cooling coil are provided and operatively connected to function such that air is conditioned in a heat mode, the cooling coil being heated in such mode, wherein an air mover is provided for passing air from a space across the cooling coil to warm the air, then back into the space, and further wherein conditioning is initiated and terminated in response to signals from a conditioner initiator, the method comprising:
alternately activating and deactivating the compressor and alternately activating and deactivating the air mover, the air mover comprising a heat mode first stage of zero speed, and a heat mode second stage of substantially full speed;
responding to a heat initiation signal from the conditioner initiator such that the compressor is activated, the condenser is activated and the air mover begins the air mover heat mode first stage; and
initiating the air mover heat mode second stage following the air mover heat mode first stage.

23. The method of claim 22, wherein the air mover heat mode first stage is approximately 15-40 seconds.

24. The method of claim 22, further comprising: responding to a heat conditioning termination signal by deactivating the compressor and deactivating the air mover after a time delay of approximately 15-95 seconds.

25. A controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising:
means providing electronic circuitry for alternately activating and deactivating the compressor and alternately activating and deactivating the air mover, the air mover activation comprising a first stage of zero speed, a second stage of reduced speed, and a third stage of substantially full speed;
the means further providing electronic circuitry such that in response to a conditioning initiation signal from the conditioner initiator, the compressor is activated, the condenser is activated and the air mover begins the air mover first stage;
the means further providing electronic circuitry such that the air mover second stage is initiated following the air mover first stage; and
the means further providing electronic circuitry such that the air mover third stage is initiated following the air mover second stage.

26. The controller of claim 25, further comprising means providing electronic circuitry such that the system responds to a conditioning termination signal from the conditioner initiator such that the compressor and the air mover are simultaneously deactivated.

27. The controller of claim 25, further comprising means providing electronic circuitry such that in response to a conditioning termination signal from the conditioner initiator the compressor is deactivated, the air mover speed is reduced for approximately 1-5 seconds beginning at the compressor deactivation, and then the air mover is deactivated.

28. The controller of claim 25, wherein the system air mover is normally continuously activated, the controller further comprising means providing electronic circuitry such that in response to a conditioning termination signal from the conditioner initiator the compressor is deactivated and the air mover is deactivated, the air mover deactivation being for an extended time period.

29. The controller of claim 28, further comprising means providing electronic circuitry such that in response to the conditioning termination signal from the conditioner initiator further comprises the compressor is deactivated, the air mover speed is reduced for approximately 1-5 seconds beginning at the compressor deactivation, and the air mover is deactivated, the air mover deactivation being for the extended time period.

30. The controller of claim 25, wherein the system further includes a reversing valve, the reversing valve being operatively connected with the compressor, condenser, expansion device, cooling coil and the air mover, to function such that air is conditioned in a heat mode, the cooling coil being heated in such mode, the controller further comprising:
means providing electronic circuitry for alternately activating and deactivating the compressor and alternately activating and deactivating the air mover, the air mover activation comprising a heat mode first stage of zero speed, and a heat mode second stage of substantially full speed;
the means further providing electronic circuitry such that in response to a heat conditioning initiation signal from the conditioner initiator the compressor is activated, the condenser is activated and the air mover begins the air mover heat mode first stage; and
the means further providing electronic circuitry such that the air mover second stage is initiated following the air mover first stage.

31. A controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising:
electronic circuitry for alternately activating and deactivating the compressor and alternately activating and deactivating the air mover, the air mover activation comprising a first stage of zero speed, a second stage of reduced speed, and a third stage of substantially full speed, the electronic circuitry being configured such that;
in response to a conditioning initiation signal from the conditioner initiator, the compressor is activated, the condenser is activated and the air mover begins the air mover first stage;
the air mover second stage is initiated following the air mover first stage; and
the air mover third stage is initiated following the air mover second stage.

32. The controller of claim 31, further comprising electronic circuitry configured such that the system responds to a conditioning termination signal from the conditioner initiator such that the compressor and the air mover are simultaneously deactivated.

33. The controller of claim 31, further comprising electronic circuitry configured such that in response to a conditioning termination signal from the conditioner initiator the compressor is deactivated, the air mover speed is reduced for approximately 1-5 seconds beginning at the compressor deactivation, and then the air mover is deactivated.

34. The controller of claim 31, wherein the system air mover is normally continuously activated, the controller further comprising electronic circuitry configured such that in response to a conditioning termination signal from the conditioner initiator the compressor is deactivated and the air mover is deactivated, the air mover deactivation being for an extended time period.

35. The controller of claim 34, further comprising electronic circuitry configured such that in response to the conditioning termination signal from the conditioner initiator further comprises the compressor is deactivated, the air mover speed is reduced for approximately 1-5 seconds beginning at the compressor deactivation, and the air mover is deactivated, the air mover deactivation being for the extended time period.

36. The controller of claim 31, wherein the system further includes a reversing valve, the reversing valve being operatively connected with the compressor, condenser, expansion device, cooling coil and the air mover, to function such that air is conditioned in a heat mode, the cooling coil being heated in such mode, the controller further comprising:
electronic circuitry for alternately activating and deactivating the compressor and alternately activating and deactivating the air mover, the air mover comprising a heat mode first stage of zero speed, and a heat mode second stage of substantially full speed;
electronic circuitry configured such that in response to a heat conditioning initiation signal from the conditioner initiator the compressor is activated, the condenser is activated and the air mover begins the air mover heat mode first stage; and
the electronic circuitry being further configured such that the air mover second stage is initiated following the air mover first stage.

37. A controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising:
first terminal set means having a plurality of terminals for electronic communication with the conditioner initiator such that one or more of the terminals are alternately energized and de-energized;
a second terminal set means having a plurality of terminals for alternately activating and deactivating the compressor, the condenser and the air mover, the air mover being activatable at a reduced speed and a normal speed;
electronic circuitry means for relaying and enabling selective and delayable electronic communications between at least some of the first terminal set means terminals and at least some of the second terminal set means terminals;
wherein in response to a conditioning initiation signal from the conditioner initiator:
the compressor is activated, the condenser is activated and the air mover begins an air mover first stage wherein the air mover is operating at zero speed;
an air mover second stage is initiated following the air mover first stage, wherein the air mover is activated at a reduced speed; and
an air mover third stage is initiated following the air mover second stage, wherein the air mover speed is activated at normal speed.

38. The controller of claim 37, wherein:
the first terminal set means plurality of terminals includes at least a C-In terminal, an R-In terminal, a Y-In terminal, and a G-In terminal;
the second terminal set means plurality of terminals includes at least a C-Out terminal, an R-Out terminal, a Y-Cond terminal, a G-Low terminal, and a G-High terminal;
the circuitry means for relaying and enabling selective and delayable electronic communications being configured such that:
the R-In, R-Out, C-In, and C-Out terminals are configured to enable electric power distribution within the controller and in cooperation with the system;
the G-In and G-Low terminals are energizable for activation and deactivation of the air mover at a reduced speed, such that when the G-In and G-Low terminals are energized the air mover is activated at reduced speed, and further such that when the G-In and G-Low terminals are not energized the air mover is off;
the G-In, G-Low, and G-High terminals are energizable for activation and deactivation of the air mover at normal speed, such that when the G-In, G-Low, and G-High terminals are energized the air mover is activated at normal speed, and further such that when the G-In, G-Low and G-High terminals are not energized the fan is off;
the Y-In and Y-Cond terminals are energizable for activation and deactivation of the condenser, such that when the Y-In and Y-Cond terminals are energized the condenser is activated, and further such that when the Y-In and Y-Cond terminals are not energized, the condenser is deactivated; and
the circuitry means further comprising a first time delay means and a second time delay means, the first time delay means delaying the energization of the G-Low terminal for the duration of the air mover first stage, the second time delay means delaying the energization of the G-High terminal for the duration of the air mover second stage.

39. The controller of claim 38, wherein a reversing valve is operatively connected with the compressor, condenser, expansion device, cooling coil and the air mover, to function such that air is conditioned in a heat mode, the cooling coil being heated in such mode, wherein the circuitry means is further configured:
for alternately activating and deactivating the compressor and alternately activating and deactivating the air mover, the air mover activation comprising a heat mode first stage of zero speed, and a heat mode second stage of substantially full speed; and
such that, in response to a heat conditioning initiation signal from the conditioner initiator:
the Y-In terminal and the Y-Cond terminal are energized such that the condenser and compressor are activated, the G-In terminal is energized, and the first time delay means is initiated, causing the air mover heat mode first stage to begin with no air mover activation; and
the G-Low terminal and the G-High terminal are energized, causing the air mover second stage to begin following the air mover first stage, the G-Low terminal and the G-High terminal energization being delayed by the first time delay means for the duration of the air mover first stage.

40. A controller for controlling a system for conditioning the air in a space, wherein a compressor, a condenser, an expansion device, and a cooling coil are provided and operatively connected to function such that air is conditioned, wherein an air mover is provided for passing air from the space across the cooling coil to cool and dehumidify the air, then back into the space, and further wherein conditioning is initiated and terminated in response to signals from a conditioner initiator, the controller comprising:
a first terminal set having a plurality of terminals for electronic communication with the conditioner initiator such that one or more of the terminals are alternately energized and de-energized;
a second terminal set having a plurality of terminals for alternately activating and deactivating the compressor, the condenser and the air mover, the air mover being activatable at a reduced speed and a normal speed;
electronic circuitry for relaying and enabling selective and delayable electronic communications between at least some of the first terminal set terminals and at least some of the second terminal set terminals;
wherein in response to a conditioning initiation signal from the conditioner initiator:
the compressor is activated, the condenser is activated and the air mover begins an air mover first stage wherein the air mover is operating at zero speed;
an air mover second stage is initiated following the air mover first stage, wherein the air mover is activated at a reduced speed; and
an air mover third stage is initiated following the air mover second stage, wherein the air mover speed is activated at normal speed.

41. The controller of claim 40, wherein:
the first terminal set plurality of terminals includes at least a C-In terminal, an R-In terminal, a Y-In terminal, and a G-In terminal;
the second terminal set plurality of terminals includes at least a C-Out terminal, an R-Out terminal, a Y-Cond terminal, a G-Low terminal, and a G-High terminal;
the circuitry for relaying and enabling selective and delayable electronic communications being configured such that:
the R-In, R-Out, C-In, and C-Out terminals are configured to enable electric power distribution within the controller and in cooperation with the system;
the G-In and G-Low terminals are energizable for activation and deactivation of the air mover at a reduced speed, such that when the G-In and G-Low terminals are energized the air mover is activated at reduced speed, and further such that when the G-In and G-Low terminals are not energized the air mover is off;
the G-In, G-Low, and G-High terminals are energizable for activation and deactivation of the air mover at normal speed, such that when the G-In, G-Low, and G-High terminals are energized the air mover is activated at normal speed, and further such that when the G-In, G-Low and G-High terminals are not energized the fan is off;
the Y-In and Y-Cond terminals are energizable for activation and deactivation of the condenser, such that when the Y-In and Y-Cond terminals are energized the condenser is activated, and further such that when the Y-In and Y-Cond terminals are not energized, the condenser is deactivated; and
the circuitry further comprising a first time delay and a second time delay, the first time delay delaying the energization of the G-Low terminal for the duration of the air mover first stage, the second time delay delaying the energization of the G-High terminal for the duration of the air mover second stage.

43. The controller of claim 41, wherein a reversing valve is operatively connected with the compressor, condenser, expansion device, cooling coil and the air mover, to function such that air is conditioned in a heat mode, the cooling coil being heated in such mode, wherein the circuitry is further configured:
for alternately activating and deactivating the compressor and alternately activating and deactivating the air mover, the air mover activation comprising a heat mode first stage of zero speed, and a heat mode second stage of substantially full speed; and
such that, in response to a heat conditioning initiation signal from the conditioner initiator:
the Y-In terminal and the Y-Cond terminal are energized such that the condenser and compressor are activated, the G-In terminal is energized, and the first time delay is initiated, causing the air mover heat mode first stage to begin with no air mover activation; and
the G-Low terminal and the G-High terminal are energized, causing the air mover second stage to begin following the air mover first stage, the G-Low terminal and the G-High terminal energization being delayed by the first time delay for the duration of the air mover first stage.
